(19) United States
(12) Patent Application Publication
(10) Pub. No.: US 2016/0255473 A1
(43) Pub. Date: Sep. 1, 2016

(54) PROXY-BASED RANGING IN A WIRELESS COMMUNICATION SYSTEM

(71) Applicant: QUALCOMM Incorporated, San Diego, CA (US)

(72) Inventors: Santosh Paul Abraham, San Diego, CA (US); Abhishek Pramod Patil, San Diego, CA (US); George Cherian, San Diego, CA (US); Alireza Raissinia, Monte Sereno, CA (US)

(21) Appl. No.: 15/055,375

(22) Filed: Feb. 26, 2016

Related U.S. Application Data
(60) Provisional application No. 62/121,475, filed on Feb. 26, 2015.

(51) Int. Cl. H04W 4/02; G01S 11/06; H04W 24/04

(52) U.S. Cl. CPC H04W 4/023; H04W 24/04; G01S 11/06

(57) ABSTRACT

A first wireless device may receive a ranging proxy indicator from a candidate ranging proxy and identify a first ranging indicator based at least in part on the ranging proxy indicator. The first ranging indicator may indicate a proximity of the first wireless device to the candidate ranging proxy. The first wireless device may receive a second ranging indicator indicating a proximity of a second wireless device to the candidate ranging proxy. The first wireless device may identify that the first wireless device and the second wireless device are within a proximity threshold based at least in part on the first ranging indicator and the second ranging indicator.

### CROSS REFERENCES

The present application for patent claims priority to U.S. Provisional Patent Application No. 62/121,475 by Abraham et al., entitled “Proxy-Based Ranging In A Wireless Communication System,” filed Feb. 26, 2015, assigned to the assignee hereof.

### BACKGROUND

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

Neighbor Awareness Networking (NAN) refers to a self-configuring peer-to-peer organization of wireless devices that enables the wireless devices to synchronize with each other and discover each other's services. A NAN cluster may be organized when a number of NAN-capable wireless devices converge in an area and discover each other. Once the wireless devices have synchronized their timings, the wireless devices may advertise their respective services to each other during an agreed upon discovery window, which increases the probability of mutual service discovery among the wireless devices in the NAN cluster.

### SUMMARY

The present disclosure relates generally to wireless communication systems, and more particularly to improved systems, methods, or apparatuses for performing proxy-based ranging in a wireless communication system. For some applications and services, the proximity (e.g., distance) between wireless devices may be a criteria for operation of the application or service. Such applications and services may, for example, alert a user when friends are at a theater, or alert a user when a loved one is near, or broadcast an availability of an extra ticket or coupon to those standing in a line, or provide a game based on the proximity of its players. For these and other applications and services, a wireless device may perform ranging to determine whether other wireless devices are within a proximity threshold of the wireless device. In some cases, the ability of a wireless device to join a NAN cluster may be conditioned on its proximity to one or more other wireless devices in the NAN cluster. In some cases, the ability of one wireless device to jointly run an application with another wireless device, or provide a service to another wireless device, may be conditioned on its proximity to the other wireless device. To determine whether wireless devices are within a proximity threshold, it can be useful to perform ranging (i.e., a service that calculates or estimates an actual or relative distance between devices). The present disclosure describes proxy-based techniques that may enable a wireless device to perform ranging faster and/or with the transmission of fewer messages.

In a first set of illustrative examples, a method for wireless communication is described. In one configuration, the method may include receiving, at a first wireless device, a ranging proxy indicator from a candidate ranging proxy; identifying a first ranging indicator based at least in part on the ranging proxy indicator, where the first ranging indicator indicates a proximity of the first wireless device to the candidate ranging proxy; receiving a second ranging indicator indicating a proximity of a second wireless device to the candidate ranging proxy; and identifying the first wireless device and the second wireless device being within a proximity threshold based at least in part on the first ranging indicator and the second ranging indicator.

In some examples of the method, the ranging proxy indicator may include at least one of: a mobility indicator, or a power indicator, or a bandwidth indicator, or an indicator of an availability to provide a ranging service, or a list of wireless devices for which the candidate ranging proxy has provided a ranging service or previously ranged with, or a list of ranging indicators, or a combination thereof. In some examples, entries in the list of wireless devices for which the candidate ranging proxy has provided a ranging service or previously ranged with may be associated with respective timing information. In some examples, the method may further include determining, based at least in part on the ranging proxy indicator, whether to range with at least one of: the candidate proxy, or a wireless device identified by the ranging proxy indicator, or a wireless device referenced in the list of wireless devices, or a combination thereof.

In some examples, the method may include receiving the ranging proxy indicator in a beacon frame transmitted by the candidate ranging proxy. In some examples, identifying the first ranging indicator may include measuring a signal strength of the beacon frame to identify the first ranging indicator. In some examples, measuring the signal strength of the beacon frame may include measuring a received signal strength indicator (RS SI) level of the beacon frame. In some examples, the method may further include mapping the signal strength to one of a plurality of signal strength levels.

In some examples, the method may include broadcasting a query for a ranging service, and receiving the ranging proxy indicator from the candidate ranging proxy in response to the query. In some examples, identifying the first ranging indicator may include measuring a signal strength of at least one transmission received from the candidate ranging proxy to identify the first ranging indicator.

In some examples of the method, identifying the first ranging indicator may include estimating a distance between the first wireless device and the candidate ranging proxy to identify the first ranging indicator. In some examples, the method may further include exchanging messages between the first wireless device and the candidate ranging proxy to estimate the distance between the first wireless device and the candidate ranging proxy. In some examples, the method may further include performing a fine timing measurement (FTM) ranging protocol to estimate the distance between the first wireless device and the candidate ranging proxy.

In some examples of the method, determining the first wireless device and the second wireless device are within the proximity threshold may include performing trilateration based at least in part on a plurality of ranging indicators associated with identifiers of a plurality of candidate ranging proxies. In some examples of the method, the second ranging indicator may be associated with at least one of: a timestamp or an expiration time.

In a second set of illustrative examples, an apparatus for wireless communication is described. In one configuration, the apparatus may include a ranging proxy indicator identifier to receive, at a first wireless device, a ranging proxy indicator from a candidate ranging proxy; a ranging indicator identifier to identify a first ranging indicator based at least in part on the ranging proxy indicator, where the first ranging indicator indicates a proximity of the first wireless device to the candidate ranging proxy; a ranging indicator receiver to receive a second ranging indicator indicating a proximity of a second wireless device to the candidate ranging proxy; and a device proximity identifier to identify the first wireless device and the second wireless device being within a proximity threshold based at least in part on the first ranging indicator and the second ranging indicator. In some examples, the apparatus may further include means for implementing one or more aspects of the method for wireless communication described above with respect to the first set of illustrative examples.

In a third set of illustrative examples, another apparatus for wireless communication is described. In one configuration, the apparatus may include a processor, memory in electronic communication with the processor, and instructions stored in the memory. The instructions may be executable by the processor to receive a ranging proxy indicator from a candidate ranging proxy; to identify a first ranging indicator based at least in part on the ranging proxy indicator, where the first ranging indicator indicates a proximity of the apparatus to the candidate ranging proxy; to receive a second ranging indicator indicating a proximity of a second apparatus to the candidate ranging proxy; and to identify the apparatus and the second apparatus being within a proximity threshold based at least in part on the first ranging indicator and the second ranging indicator. In some examples, the instructions may also be executable by the processor to implement one or more aspects of the method for wireless communication described above with respect to the first set of illustrative examples.

In a fourth set of illustrative examples, a non-transitory computer-readable medium storing computer-executable code for wireless communication is described. In one configuration, the code may be executable by a processor to receive, at a first wireless device, a ranging proxy indicator from a candidate ranging proxy; to identify a first ranging indicator based at least in part on the ranging proxy indicator, where the first ranging indicator indicates a proximity of the first wireless device to the candidate ranging proxy; to receive a second ranging indicator indicating a proximity of a second wireless device to the candidate ranging proxy; and to identify the first wireless device and the second wireless device being within a proximity threshold based at least in part on the first ranging indicator and the second ranging indicator. In some examples, the non-transitory computer-readable medium may also include instructions to implement one or more aspects of the method for wireless communication described above with respect to the first set of illustrative examples.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If the first reference label is used in the specification, the description is applicable to any one of the similar components having the same first reference label irrespective of the second reference label.

FIG. 1 illustrates an example of a wireless communication system in which wireless devices may perform ranging using one or more candidate ranging proxies, in accordance with various aspects of the present disclosure;

FIG. 2A is a swim lane diagram illustrating the performance of ranging by a first wireless device, in accordance with various aspects of the present disclosure;

FIG. 2B illustrates an example ranging proxy indicator, in accordance with various aspects of the present disclosure;

FIG. 2C illustrates an example ranging indicators, in accordance with various aspects of the present disclosure;

FIG. 3A is a swim lane diagram illustrating the performance of ranging by a first wireless device, in accordance with various aspects of the present disclosure;

FIG. 3B illustrates an example beacon frame, in accordance with various aspects of the present disclosure;

FIG. 3C illustrates an example device ranging list (DRL), in accordance with various aspects of the present disclosure;

FIG. 4 is a swim lane diagram illustrating the performance of ranging by a first wireless device, in accordance with various aspects of the present disclosure;

FIG. 5 shows a block diagram of an apparatus configured for performing ranging using one or more candidate ranging proxies, in accordance with various aspects of the present disclosure;

FIG. 6 shows a block diagram of an apparatus configured for performing ranging using one or more candidate ranging proxies, in accordance with various aspects of the present disclosure;

FIG. 7 shows a block diagram of an apparatus configured for performing ranging using one or more candidate ranging proxies, in accordance with various aspects of the present disclosure;

FIG. 8 shows a block diagram of an apparatus configured for performing ranging using one or more candidate ranging proxies, in accordance with various aspects of the present disclosure;

FIG. 9 illustrates a wireless device configured for performing ranging using one or more candidate ranging proxies, in accordance with various aspects of the present disclosure;

FIG. 10 is a flow chart illustrating an example of a method for wireless communication, in accordance with various aspects of the present disclosure;

FIG. 11 is a flow chart illustrating an example of a method for wireless communication, in accordance with various aspects of the present disclosure; and

FIG. 12 is a flow chart illustrating an example of a method for wireless communication, in accordance with various aspects of the present disclosure.

### DETAILED DESCRIPTION

The described features generally relate to improved systems, methods, or apparatuses for performing proxy-based ranging in a wireless communication system. In some embodiments, a wireless device may perform ranging using one or more candidate ranging proxies. A candidate ranging proxy may take the form of a wireless device serving as a master device within a NAN cluster, a wireless device serving as a non-master device within the NAN cluster, or a wireless device operating independently of the NAN cluster. A candidate ranging proxy may be a wireless device that determines it has limited mobility (e.g., a wireless device that it is permanently or temporarily stationary), or a wireless device that determines it has sufficient power to be useful as a ranging proxy, or a wireless device that determines it has sufficient bandwidth to execute a ranging protocol, or a wireless device that determines it has a low enough processing load to enable it to provide a ranging service, or a combination thereof. A candidate ranging proxy may explicitly or implicitly communicate its availability as a candidate ranging proxy to other wireless devices.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

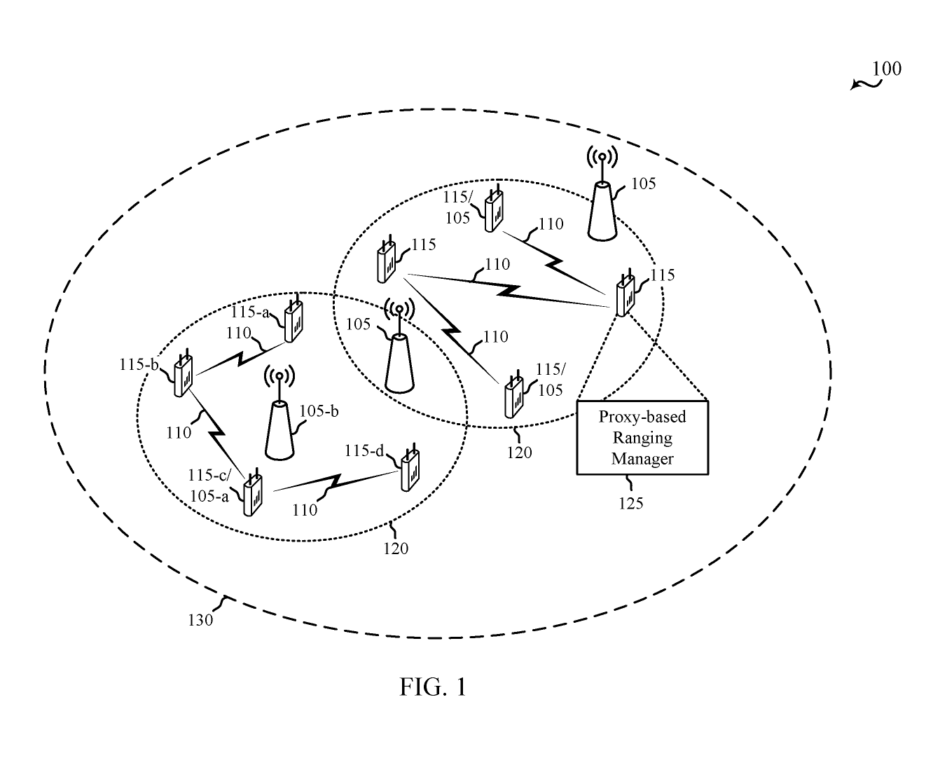

FIG. 1 illustrates an example of a wireless communication system 100 in which wireless devices 115 may perform ranging using one or more candidate ranging proxies 105, in accordance with various aspects of the present disclosure. The wireless communication system 100 includes a number of wireless devices 115 in communication with each other via wireless communication links 110. In some examples, the wireless devices 115 may be devices capable of communicating according to NAN protocols and may include sensors, personal digital assistants (PDAs), mobile communication devices (e.g., phones, tablets, and laptops), and the like. In some cases, a wireless device 115 may be a wireless station (STA) capable of accessing wireless local area networks (WLANs) such as Wi-Fi basic service sets (BSSs), independent basic service sets (IBSSs), and Wi-Fi Direct connections. In some examples, a wireless device 115 may be a NAN-capable device, a NAN sensor, a NAN unit, or other type of NAN device.

A group of wireless devices 115 (e.g., the wireless devices 115-a, 115-b, 115-c, and 115-d) that are synchronized to a common timing scheme and which collectively operate according to a common set of NAN parameters may make up a NAN cluster 120. A group of wireless devices 115 that are not necessarily synchronized, but which share common NAN parameters (e.g., beacon interval and NAN channels) may form a NAN network 130. Thus, a NAN network 130 may include one or more NAN clusters 120. To join a NAN cluster 120, a wireless device 115 may synchronize its clock to the timing scheme of the NAN cluster 120 using a synchronization beacon broadcast by one or more NAN devices (e.g., one or more of the wireless devices 115) already operating within the NAN cluster 120. Once synchronized to the NAN cluster 120, a wireless device 115 may communicate with other wireless devices 115 in the NAN cluster 120 by transmitting and receiving signals during a discovery window (i.e., a time period and channel on which all wireless devices 115 within the NAN cluster 120 converge to exchange synchronization and service information). A wireless device 115 may discover the presence of a nearby NAN cluster 120 based on a discovery beacon, which may be broadcast between synchronization beacons and outside of discovery windows.

Different wireless devices 115 may assume or be assigned different roles within a NAN cluster 120. For example, a wireless device 115 may serve as either a master device or a non-master device (i.e., a wireless device 115 may be in a master mode or a non-master mode). A wireless device 115 may identify its role within the NAN cluster 120 based at least in part on a received signal strength indicator (RSSI) level measured for a signal received from the nearest master device (e.g., if the RSSI level of the nearest master device is below a threshold, the wireless device 115 may assume the role of a master device). A non-master device may be in one of two states: a sync state or a non-sync state. While in a sync state, a non-master device may transmit synchronization beacons, but not discovery beacons. While in a non-sync state, a non-master device may not transmit synchronization beacons or discovery beacons. However, a master device may transmit both synchronization beacons and discovery beacons. A master device that is responsible for supplying the system timing for a NAN cluster 120 may be known as an anchor master. For example, an anchor master device may broadcast a timing synchronization function (TSF) to other wireless devices 115 in the NAN cluster 120 via synchronization beacons. Thus, the timing of all wireless devices 115 within the NAN cluster 120 may be synchronized according to the TSF.

A wireless device 115 may identify services offered by other wireless devices 115 via service discovery frames, which may be transmitted by master devices or non-master devices. A service discovery frame may be a Vendor Specific Public Action Frame, as defined in IEEE Std. 802.11-2012. Within a NAN cluster 120, service discovery frames may be multicast (i.e., sent from one wireless device 115 to multiple other wireless devices 115) or unicast (i.e., sent from one wireless device 115 to another wireless device 115). The service discovery frames may include fields for the transmission of data from one wireless device 115 to another. For example, a wireless device 115 may transmit information to a different wireless device 115 via a service descriptor attribute, which may be one of the NAN attributes included in a service discovery frame. Thus, a wireless device 115 may use a service discovery frame to transmit information corresponding to itself, or to relay information received from another wireless device 115.

For some applications and services, the proximity (e.g., distance) between wireless devices 115 may be a criteria for operation of the application or service. Thus, it may be useful to perform ranging to determine whether wireless devices 115 are within a proximity threshold of one another. In some cases, the ability of a wireless device 115 to join a NAN cluster 120 may be conditioned on its proximity to one or more other wireless devices 115 in the NAN cluster 120. In some cases, the ability of one wireless device 115 to jointly run an application with another wireless device 115, or to provide a service to another wireless device 115, may be conditioned on its proximity to the other wireless device 115.

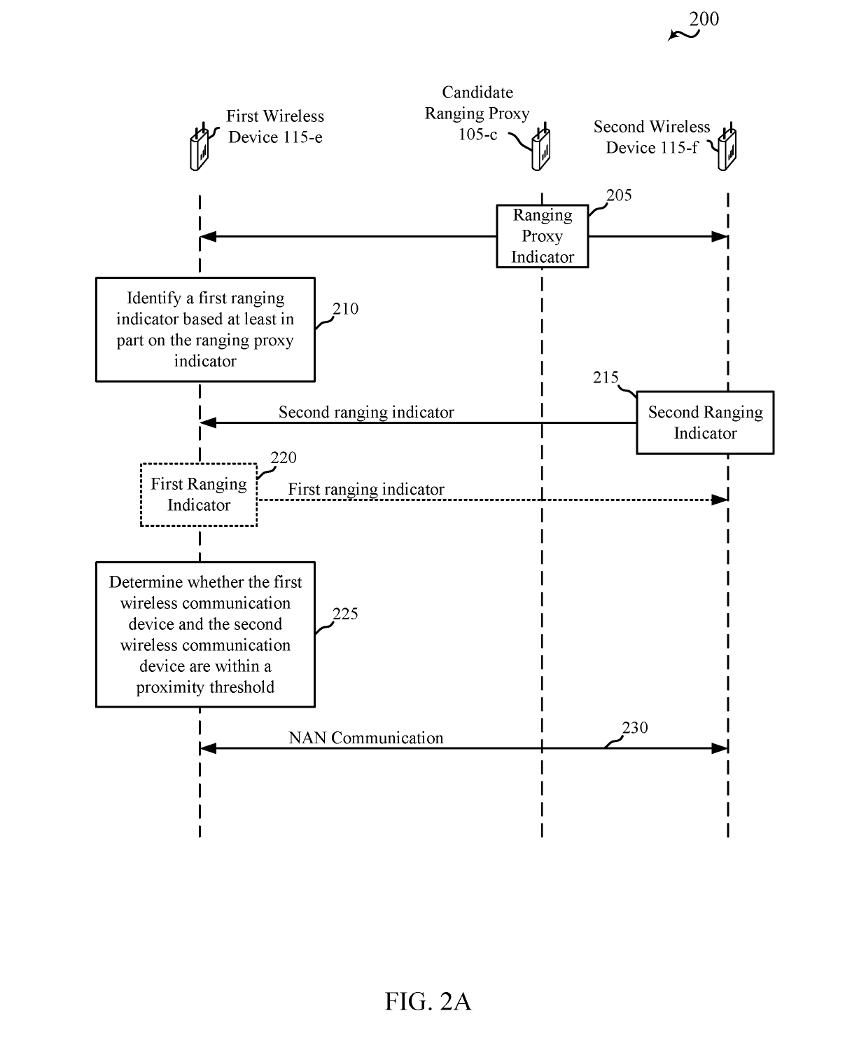

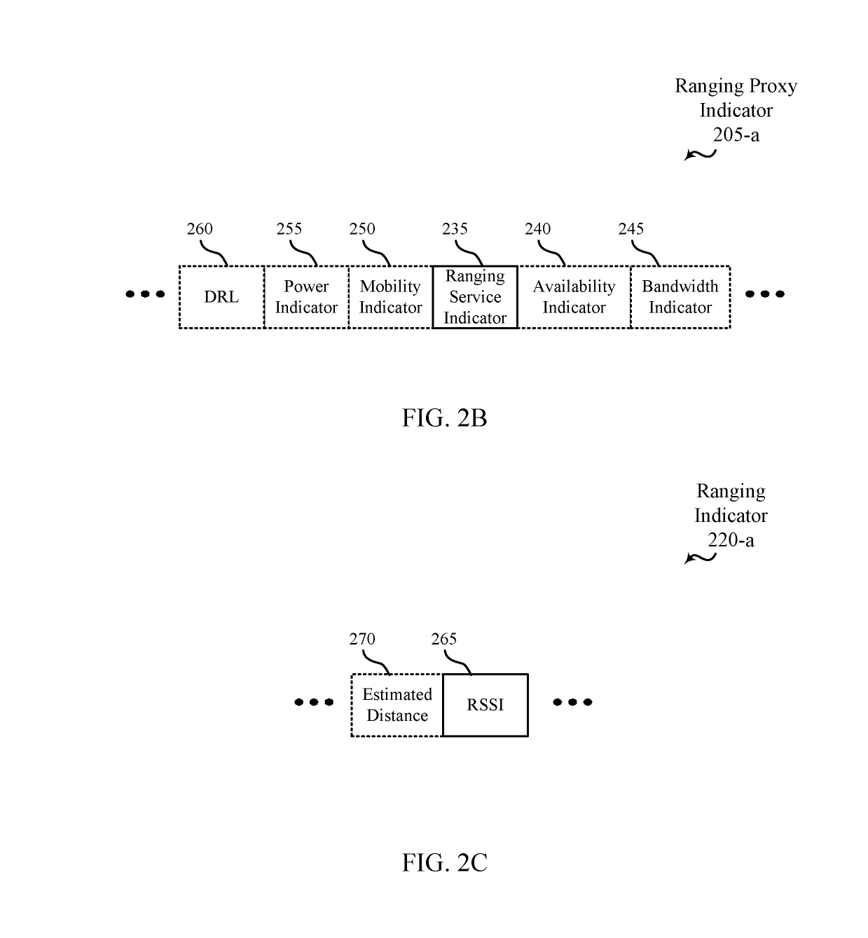

In some embodiments, a wireless device 115 may include a proxy-based ranging manager 125 to perform ranging using one or more candidate ranging proxies 105. Details regarding the proxy-based ranging manager 125 will be described below. A candidate ranging proxy 105 may take the form of a wireless device 115-c/105-a serving as a master device within a NAN cluster 120, a wireless device 115 serving as a non-master device within the NAN cluster 120, a wireless device (e.g., a WLAN access point) operating independently of the NAN cluster 120 (e.g., the candidate ranging proxy 105-b), etc. A candidate ranging proxy 105 may be a wireless device that determines it has limited mobility (e.g., a wireless device that it is permanently or temporarily stationary), or a wireless device that determines it has sufficient power to be useful as a ranging proxy, or a wireless device that determines it has sufficient bandwidth to execute a ranging protocol, or a wireless device that determines it has a low enough processing load to enable it to provide a ranging service, or a combination thereof. The use of one or more candidate ranging proxies 105 by a wireless device 115 to perform proxy-based ranging is described with reference to FIGS. 2-12.

FIG. 2A is a swim lane diagram 200 illustrating the performance of ranging by a first wireless device 115-e, in accordance with various aspects of the present disclosure. In some examples, each of the first wireless device 115-e and a second wireless device 115-f may be an example of aspects of one or more of the wireless devices 115 described with reference to FIG. 1. Similarly, a candidate ranging proxy 105-c may be an example of aspects of one or more of the candidate ranging proxies 105, or aspects of one or more of the wireless devices 115 operating as a candidate ranging proxy, as described with reference to FIG. 1.

In some examples, the candidate ranging proxy 105-c may transmit a ranging proxy indicator 205, which may be received by the first wireless device 115-e. The ranging proxy indicator 205 may be transmitted alone or with other data (e.g., in a beacon frame). The ranging proxy indicator 205 may be transmitted in a unicast transmission to a single wireless device, such as the first wireless device 115-e, or in a broadcast transmission receivable by any wireless device within range of candidate ranging proxy 105-c (e.g., by the first wireless device 115-e and the second wireless device 115-f, as shown). In some cases, the ranging proxy indicator 205 may be included in a transmission transmitted specifically for ranging, or in a transmission that has other purposes (e.g., a device discovery transmission).

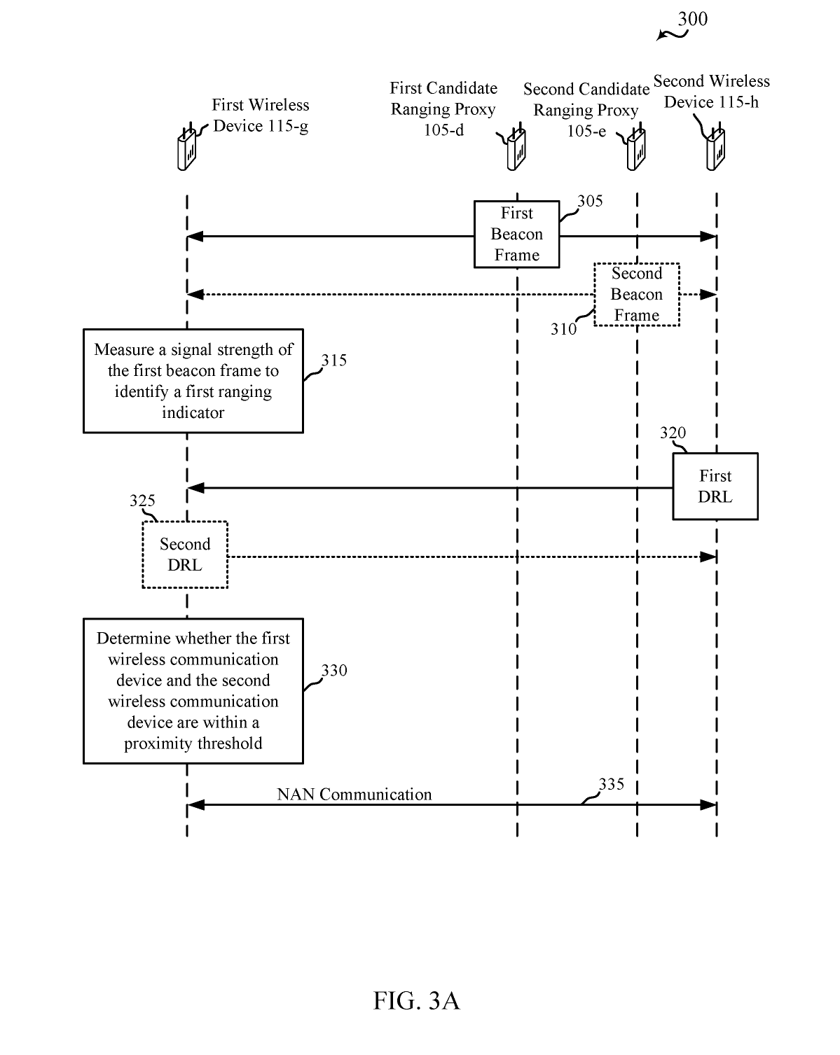

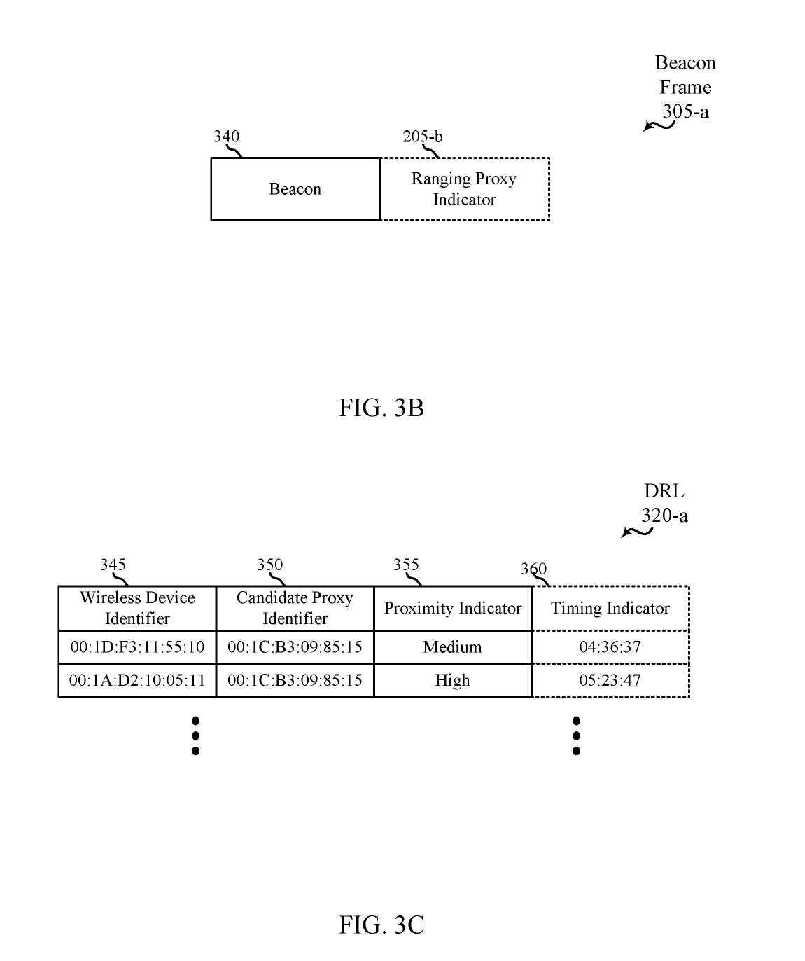

In some examples, the ranging proxy indicator 205 may be used to indicate a ranging capability of candidate ranging proxy 105-c or information related to ranging characteristics of candidate ranging proxy 105-c. For instance, ranging proxy indicator 205 may be express and include at least one of: a mobility indicator, or a power indicator, or a bandwidth indicator, or an indicator of an availability to provide a ranging service, or a list of wireless devices for which the candidate ranging proxy has provided a ranging service or previously ranged with, or a list of ranging indicators (e.g., a device range list (DRL) as further described below and with reference to FIG. 3B), or a combination thereof, and as further discussed in FIG. 2B. When the ranging proxy indicator 205 includes a list of wireless devices for which the candidate ranging proxy 105-c has provided a ranging service or previously ranged with, or a list of ranging indicators, entries in the list of wireless devices (or ranging indicators in the list of ranging indicators) may be associated with respective timing information (e.g., a timestamp or an expiration time). The timing information may be used by the first wireless device 115-e to determine whether the associated information is still valid or useful. In some embodiments, the first wireless device 115-e may use the ranging proxy indicator 205 to determine whether to range with the candidate ranging proxy 105-c and/or one or more wireless devices identified by the ranging proxy indicator 205.

In other examples, the ranging proxy indicator 205 may be implied, and may be a transmission (or particular type of transmission) made by the candidate ranging proxy 105-c after determining that the candidate ranging proxy 105-c has limited mobility (e.g., after determining that it is permanently or temporarily stationary), or that the candidate ranging proxy 105-c has sufficient power to be useful as a ranging proxy, or that the candidate ranging proxy 105-c has sufficient bandwidth to execute a ranging protocol, or that the candidate ranging proxy 105-c has a low enough processing load to enable it to provide a ranging service. When the ranging proxy indicator 205 is express, the ranging proxy indicator 205 may include a Boolean indicator (e.g., a TRUE or FALSE indicator) or a value (e.g., a power level that the first wireless device 115-e may compare to a threshold power level for the purpose of determining whether the candidate ranging proxy 105-c is a suitable ranging proxy).

At block 210, the first wireless device 115-e may identify a first ranging indicator 220 based at least in part on the ranging proxy indicator received at 205. The first ranging indicator 220 may indicate a proximity of/distance from the first wireless device 115-e to the candidate ranging proxy 105-c. In some examples, determining the first ranging indicator 220 may include measuring a signal strength (e.g., a received signal strength indicator (RSSI) level) of at least one transmission received from the candidate ranging proxy 105-c. The measured RSSI value may be indicative of a distance from the first wireless device 115-e to the candidate ranging proxy 105-c. Identifying the first ranging indicator 220 may also or alternatively include estimating a distance between the first wireless device 115-e and the candidate ranging proxy 105-c.

The first wireless device 115-e may receive a second ranging indicator 215 indicating a proximity of the second wireless device 115-f to the candidate ranging proxy 105-c. The second ranging indicator 215 may be identified by the second wireless device 115-f similarly to how the first ranging indicator 220 is identified by the first wireless device 115-e. That is, wireless device 115-f may determine a distance from candidate ranging proxy 105-c by measuring a signal strength of transmissions from candidate ranging proxy 105-c. The second ranging indicator 215 may be received directly from the second wireless device 115-f (as shown), or transmitted via one or more intermediate devices, such as the candidate ranging proxy 105-c. In some cases, the second ranging indicator 215 may be received in a first DRL. The first DRL may be received, in some embodiments, in a publish or subscribe frame of a NAN.

The first wireless device 115-e may optionally transmit the first ranging indicator 220 to the second wireless device 115-f and/or other wireless devices. The first ranging indicator 220 may be transmitted directly to the second wireless device 115-f (as shown), or transmitted via one or more intermediate devices, such as the candidate ranging proxy 105-c. In some cases, the first ranging indicator 220 may be transmitted in a second DRL. The second DRL may be transmitted, in some embodiments, in a publish or subscribe frame of a NAN.

At block 225, the first wireless device 115-e may determine whether the first wireless device 115-e and the second wireless device 115-f are within a proximity threshold. That is, the first wireless device 115-e may use the determined proximity indicators 215 and/or 220 to determine whether the second wireless device 115-e is close enough to the first wireless device 115-e to support NAN communications between the devices. In one example, when each of the first ranging indicator 220 and the second ranging indicator 215 includes a measured signal strength, determining whether the first wireless device 115-e and the second wireless device 115-f are within the proximity threshold may include determining whether each of a first signal strength (indicated by the first ranging indicator 220) and a second signal strength (indicated by the second ranging indicator 215) satisfy a signal strength threshold (e.g., that each signal strength exceeds the same signal strength threshold or a respective signal strength threshold).

Also or alternatively, determining whether the first wireless device 115-e and the second wireless device 115-f are within the proximity threshold may include determining whether each of the first signal strength and the second signal strength satisfy one of a number of relationships. When each of the first ranging indicator 220 and the second ranging indicator 215 includes an estimated distance, determining whether the first wireless device 115-e and the second wireless device 115-f are within the proximity threshold may include determining whether the sum of a first distance (indicated by the first ranging indicator 220) and a second distance (indicated by the second ranging indicator 215) satisfies a sum threshold (e.g., that the sum is lower than the sum threshold).

Upon identifying that the first wireless device 115-e and the second wireless device 115-f are within the proximity threshold, the first wireless device 115-e may establish wireless communication (e.g., NAN communication) with the second wireless device 115-f at 230.

FIG. 2B illustrates an example ranging proxy indicator 205-a in accordance with the present disclosure. Ranging proxy indicator 205-a may be an example of a ranging proxy indicator 205 as described with reference to FIG. 2A.

Ranging proxy indicator 205-a may be an example of the information included in a ranging proxy transmissions. For example ranging proxy indicator 205-a may include a single field which may be used to communicate different types of ranging proxy indicator information, such as a ranging service indicator field 235. The ranging service indicator field 235 an indicator of whether the proxy device is available for or capable of providing ranging service. A wireless device that receives ranging service indicator field 235 may determine that a ranging proxy candidate is capable of ranging services and begin ranging procedures.

In other examples, ranging proxy indicator 205-a may include additional fields including other information such as a mobility indicator field 250, which may indicate that the candidate ranging proxy 105-c has limited mobility (e.g., after determining that it is permanently or temporarily stationary), a power indicator field 255, which indicates that the candidate ranging proxy 105-c has sufficient power to be useful as a ranging proxy, a bandwidth indicator field 245, which indicates that the candidate ranging proxy 105-c has sufficient bandwidth to execute a ranging protocol, or an ranging service availability indicator field 240, which indicates that the candidate ranging proxy 105-c has a low enough processing load to enable ranging services. These fields may be indicated using a Boolean indicator (e.g., a TRUE or FALSE indicator) or may provide a value (e.g., a power level) that the first wireless device 115-e may compare to a threshold power level for the purpose of determining whether the candidate ranging proxy 105-c is a suitable ranging proxy.

In some examples, the ranging proxy indicator 205-a may include a list of ranging indicators included in a DRL field 260, or a list of wireless devices for which the candidate ranging proxy has provided a ranging service or previously ranged with. Entries in the list of wireless devices (or ranging indicators in the list of ranging indicators) may be associated with respective timing information (e.g., a timestamp or an expiration time). The timing information may be used by the first wireless device 115-e to determine whether the associated information is still valid or useful. In some embodiments, the first wireless device 115-e may use the ranging proxy indicator 205-a to determine whether to range with the candidate ranging proxy 105-c and/or one or more wireless devices identified by the ranging proxy indicator. In other examples, the ranging proxy indicator may be implied, and may be a transmission (or particular type of transmission) made by the candidate ranging proxy 105-c after determining.

In some cases, ranging proxy indicator 205-a includes additional fields including different types of information. In some examples, different combinations of the fields are possible and certain fields may be omitted, rearranged, or otherwise modified. For instance, in some examples ranging proxy indicator 205-a is constructed using two fields that include the mobility indicator field 250 and the ranging service indicator 235. Similarly, ranging proxy indicator 205-a may be constructed using three fields, four fields, etc. Different combinations of the fields 235 to 260 may be included in the available fields in ranging proxy indicator 205-a.

FIG. 2C illustrates an example ranging indicator 220-a in accordance with the present disclosure. Ranging indicator 220-a may be an example of second ranging indicator 215 or first ranging indicator 220 with reference to FIG. 2A.

Ranging indicator 220-a may be an example of the information included in ranging indicator transmissions. For example, ranging indicator 220-a may include a single field which may be used to communicate different types of ranging indicator information. In some examples, this field may include an indication of the distance between the first wireless device 115-e and the candidate ranging proxy 105-c. In some examples, the first wireless device 115-e may determine ranging indicator information by measuring a signal strength (e.g., a received signal strength indicator (RSSI) level) of a transmission received from the candidate ranging proxy 105-c. The measured RSSI or an indication of the measured RSSI may then be included in ranging indicator 220-a using RSSI field 265. In some cases, RSSI field 265 may convey two bits of information to indicate signal strength information—e.g., the measured signal strength may be mapped to a 2-bit signal strength level, where: 00=low signal strength, 01=medium signal strength, and 10=high signal strength.

Additionally or alternatively, the first wireless device 115-e may estimate a distance between the first wireless device 115-e and the candidate ranging proxy 105-c (e.g., based on the RSSI, timing information, etc.). The estimated distance or an indication of the estimated distance may be included in the ranging indicator 220-a via estimated distance field 270. In some cases, ranging indicator 220-a includes one or both of the estimated distance field 270 and the RSSI field 265. In some examples, different combinations of the fields are possible and certain fields may be omitted, rearranged, or otherwise modified.

FIG. 3A is a swim lane diagram 300 illustrating the performance of ranging by a first wireless device 115-g, in accordance with various aspects of the present disclosure. In some examples, each of the first wireless device 115-g and a second wireless device 115-h may be an example of aspects of one or more of the wireless devices 115 described with reference to FIG. 1 or 2. Similarly, each of a first candidate ranging proxy 105-d and a second candidate ranging proxy 105-e may be an example of aspects of one or more of the candidate ranging proxies 105, or aspects of one or more of the wireless devices 115 operating as a candidate ranging proxy, as described with reference to FIG. 1 or 2.

The first candidate ranging proxy 105-d may transmit a first beacon frame 305 and the first wireless device 115-g may receive the first beacon frame 305. In some examples, the first beacon frame 305 may be transmitted in a broadcast transmission receivable by any wireless device (e.g., by the first wireless device 115-g and the second wireless device 115-h, as shown). Optionally, the first beacon frame 305 may include a first ranging proxy indicator as discussed above and shown with respect to FIG. 3B.

The second candidate ranging proxy 105-e may optionally transmit a second beacon frame 310 and the first wireless device 115-g may receive the second beacon frame 310. In some examples, the second beacon frame 310 may be transmitted in a broadcast transmission receivable by any wireless device (e.g., by the first wireless device 115-g and the second wireless device 115-h, as shown). The second beacon frame 310 may include a second ranging proxy indicator.

If ranging proxy indicators are included in beacon frame 305 or beacon frame 310, each of the first ranging proxy indicator and the second ranging proxy indicator may include at least one of: a mobility indicator, or a power indicator, or a bandwidth indicator, or an indicator of an availability to provide a ranging service, or a list of wireless devices for which the candidate ranging proxy has provided a ranging service or previously ranged with, or a list of ranging indicators, or a combination thereof. When the first ranging proxy indicator or the second ranging proxy indicator includes a list of wireless devices for which the first candidate ranging proxy 105-d or the second candidate ranging proxy 105-e has provided a ranging service or previously ranged with, or a list of ranging indicators, entries in the list of wireless devices (or ranging indicators in the list of ranging indicators) may be associated with respective timing information (e.g., a timestamp or an expiration time). The timing information may be used by the first wireless device 115-g to determine whether the associated information is still valid or useful. In some embodiments, the first wireless device 115-g may use the first ranging proxy indicator or the second ranging proxy indicator to determine whether to range with the first candidate ranging proxy 105-d, the second candidate ranging proxy 105-e, and/or one or more wireless device identified by the first ranging proxy indicator or the second ranging proxy indicator.

At block 315, if a ranging proxy indicator is included in the first beacon frame 305, the first wireless device 115-g may identify a first ranging indicator based at least in part on the first ranging proxy indicator. The first ranging indicator may indicate a proximity of the first wireless device 115-g to the first candidate ranging proxy 105-d. Additionally or alternatively if a ranging proxy indicator is not included in the first beacon frame 305, identifying the first ranging indicator may include measuring a signal strength (e.g., a received signal strength indicator (RSSI) level) of the first beacon frame 305. To reduce error rate, measuring the signal strength of the first beacon frame 305 may include measuring the signal strength of a plurality of received instances of the first beacon frame 305, and determining an average measured signal strength of the first beacon frame 305. Measuring the signal strength of the first beacon frame 305 may also include mapping the measured signal strength (or average measured signal strength) to one of a plurality of signal strength levels. For example, the measured signal strength may be mapped to a 2-bit signal strength level, where: 00=low signal strength, 01=medium signal strength, and 10=high signal strength.

The first wireless device 115-g may receive a first DRL 320 from the second wireless device 115-h. The first DRL 320 may include a second ranging indicator indicating a proximity of the second wireless device 115-h to the first candidate ranging proxy 105-d. The second ranging indicator may be identified by the second wireless device 115-h similarly to how the first ranging indicator is identified by the first wireless device 115-g. That is, based on a measured signal strength of the first beacon frame 305 or the second beacon frame 310 or based on a ranging proxy indicator if included. Although the first DRL 320 may be received directly from the second wireless device 115-h (as shown), the first DRL 320 may also be transmitted via one or more intermediate devices, such as the first candidate ranging proxy 105-d or the second candidate ranging proxy 105-e. The first DRL 320 may be received, in some embodiments, in a publish or subscribe frame of a NAN.

At 325, the first wireless device 115-g may optionally transmit a second DRL 325 to the second wireless device 115-h and/or other wireless devices. The second DRL 325 may include the first ranging indicator. The second DRL 325 may be transmitted directly to the second wireless device 115-h (as shown), or transmitted via one or more intermediate devices, such as the first candidate ranging proxy 105-d or the second candidate ranging proxy 105-e. The second DRL 325 may be transmitted, in some embodiments, in a publish or subscribe frame of a NAN.

At block 330, the first wireless device 115-g may determine whether the first wireless device 115-g and the second wireless device 115-h are within a proximity threshold—i.e., near enough to one another to establish NAN communication. The determination may be based at least in part on the first ranging indicator and the second ranging indicator. When each of the first ranging indicator and the second ranging indicator includes a measured signal strength, determining whether the first wireless device 115-g and the second wireless device 115-h are within the proximity threshold may include determining whether each of a first signal strength (indicated by the first ranging indicator) and a second signal strength (indicated by the second ranging indicator) satisfy a signal strength threshold (e.g., that each signal strength exceeds the same signal strength threshold or a respective signal strength threshold). Also or alternatively, determining whether the first wireless device 115-g and the second wireless device 115-h are within the proximity threshold may include determining whether each of the first signal strength and the second signal strength satisfy one of a number of relationships. For example, the first wireless device 115-g and the second wireless device 115-h may be identified as being within the proximity threshold when at least one of the signal strengths (e.g., the first signal strength or the second signal strength) is a medium or high signal strength, and when at least one of the signal strengths is a high signal strength. When the signal strengths do not meet these criteria, the first wireless device 115-g and the second wireless device 115-h may be identified as being outside (i.e., not meeting) the proximity threshold.

Upon identifying that the first wireless device 115-g and the second wireless device 115-h are within the proximity threshold, the first wireless device 115-g may establish wireless communication (e.g., NAN communication) with the second wireless device 115-h at 335.

In some embodiments of the ranging demonstrated by the swim lane diagram 300, the operation(s) at block 315 may include identifying a plurality of ranging indicators, with a set of the ranging indicators indicating proximities of the first wireless device 115-g to a plurality of candidate ranging proxies. For example, in addition to identifying the first ranging indicator, the first wireless device 115-g may identify a third ranging indicator based at least in part on the second ranging proxy indicator received in the second beacon frame at 310. The third ranging indicator may indicate a proximity of the first wireless device 115-g to the second candidate ranging proxy 105-e.

In some embodiments of the ranging demonstrated by the swim lane diagram 300, the first DRL 320 may include a plurality of ranging indicators, with a set of the ranging indicators indicating proximities of the second wireless device 115-h to a plurality of candidate ranging proxies. For example, in addition to including the second ranging indicator, the first DRL 320 may include a fourth ranging indicator indicating a proximity of the second wireless device 115-h to the second candidate ranging proxy 105-e. In some examples, the first DRL 320 may include a number of entries, with each entry including an identifier of a candidate ranging proxy (e.g., a master device address or a medium access control (MAC) address) associated with a ranging indicator (e.g., an RSSI level indicator) indicating a proximity of the second wireless device 115-h to the identified candidate ranging proxy. In some embodiments, each ranging indicator included in the first DRL 320 may be associated with at least one of: a timestamp or an expiration time.

In some embodiments of the ranging demonstrated by the swim lane diagram 300, the second DRL 325 may include a plurality of ranging indicators, with at least some of the ranging indicators indicating proximities of the first wireless device 115-g to a plurality of candidate ranging proxies. For example, in addition to including the first ranging indicator, the second DRL 325 may include the third ranging indicator. The second DRL 325 may be formatted similarly to the first DRL 320, and may include a set of ranging indicators indicating proximities to the same or different set of candidate ranging proxies as the first DRL 320.

In some embodiments of the ranging demonstrated by the swim lane diagram 300, the first wireless device 115-g may determine whether the first wireless device 115-g and the second wireless device 115-h are within a proximity threshold, at block 330, based at least in part on a plurality of ranging indicators indicating the proximities of the first wireless device 115-g and the second wireless device 115-h to a plurality of candidate ranging proxies. For example, consider the first ranging indicator, the second ranging indicator, the third ranging indicator, and the fourth ranging indicator, which may indicate a respective first signal strength, second signal strength, third signal strength, and fourth signal strength. In such an example, the first wireless device 115-g and the second wireless device 115-h may be identified as being within the proximity threshold when each of the signal strengths is a medium or high signal strength. When the signal strengths do not meet these criteria, the first wireless device 115-g and the second wireless device 115-h may be identified as being outside (i.e., not meeting) the proximity threshold. As the number of candidate ranging proxies to which both the first wireless device 115-g and the second wireless device 115-h are proximate increases, the likelihood that the devices are proximate increases (i.e., the error rate of incorrectly identifying the devices as proximate decreases) and the likelihood of the devices being closer increases.

FIG. 3B illustrates an example beacon frame 305-a in accordance with the present disclosure. Beacon fame 305-a may be an example of a first beacon frame 305 or a second beacon frame 310 as discussed with reference to FIG. 3A.

Beacon frame 305-a may include a beacon 340 and, in some cases, may also include a ranging proxy indicator 205-c. Ranging indicator 205-c may be constructed as described with respect to ranging indicator 205-a discussed in FIG. 2B. In some cases beacon 340 may include preamble fields such as a first training field and a second training field, which may be used for discovery procedures and/or for determining signal strength information for a transmitted beacon frame. In some examples, beacon 340 may include additional data and may also include reference signals used to decode the data. These reference signals may also be used to determine signal strength information. In some examples, beacon 340 communicates timing information to a wireless device, which may be used to determine a proximity to a candidate proxy. In some examples, beacon frame 305-a may additionally include a ranging proxy indicator 205-b. Ranging proxy indicator 205-b may include ranging proxy information and may be used to communicate that the device transmitting the beacon frame is capable of/enabled for ranging services as described above with reference to FIGS. 2A and 2B.

FIG. 3C illustrates an example DRL 320-a in accordance with the present disclosure. DRL 320-a may be an example of a DRL 260, a first DRL 320, or a second DRL 325 as discussed with reference to FIGS. 2B and 3A.

DRL 320-a may include a wireless device identifier field 345, a candidate proxy identifier field 350, a proximity indicator field 355, and a timing indicator field 360. The wireless device identifier field 345 may be used to identify the wireless device that is associated with the determined proximity information (i.e., a ranging indicator). Candidate proxy identifier field 350 may be used to indicate for which candidate proxy device the determined proximity information is relevant. That is, using a wireless device ID and a candidate proxy ID, a wireless device may determine the wireless device and the candidate proxy device that are associated with the proximity information provided in proximity indicator field 355 and determine an indication of the distance between the wireless device and the candidate proxy device. Both the wireless device identifier field 345 and the candidate proxy identifier field 350 may use unique identifiers for the wireless and proxy devices, such as a MAC address or a master device address.

The proximity indicator field 355 may be used to communicate an indication of the proximity of a wireless device to a corresponding candidate proxy device. In some examples, proximity indicator field 355 includes an RSSI field which indicates discrete levels of measured signal strengths for the corresponding candidate proxy device. Additionally or alternatively, proximity indicator field 355 includes a distance estimation field which indicates an estimated distance between the wireless device and candidate proxy device. The timing indicator field 360 may optionally be used to indicate timing information to a wireless device. This timing information may be used by a device to determine if a received ranging indicator for a different wireless device may still be used for proximity detection. In some examples, the timing indicator field 360 includes a timestamp or an expiration time.

In one example of proximity detection, a wireless device (e.g., first wireless device 115-g) that receives DRL 320-a from a different device (e.g., second wireless device 115-h) may first identify a corresponding device ID (e.g., 00:1A:D2:10:05:11) for the different wireless device. Then based on DRL 320-a, the wireless device may determine that the different wireless device is close in distance to a candidate proxy device (e.g., first candidate ranging proxy 105-d) with candidate proxy ID (00:1C:B3:09:85:15) based on the proximity indicator field 355 indicating a high RSSI value. In some cases, the wireless device may then determine a distance between itself and the same candidate proxy device, for example using a previously measured RSSI of signals received from the candidate proxy device. In some examples, if the wireless device determines the measured RSSI corresponds to a medium level or higher, the wireless device may determine that the wireless device is in close enough proximity to the different wireless device to initiate NAN communications.

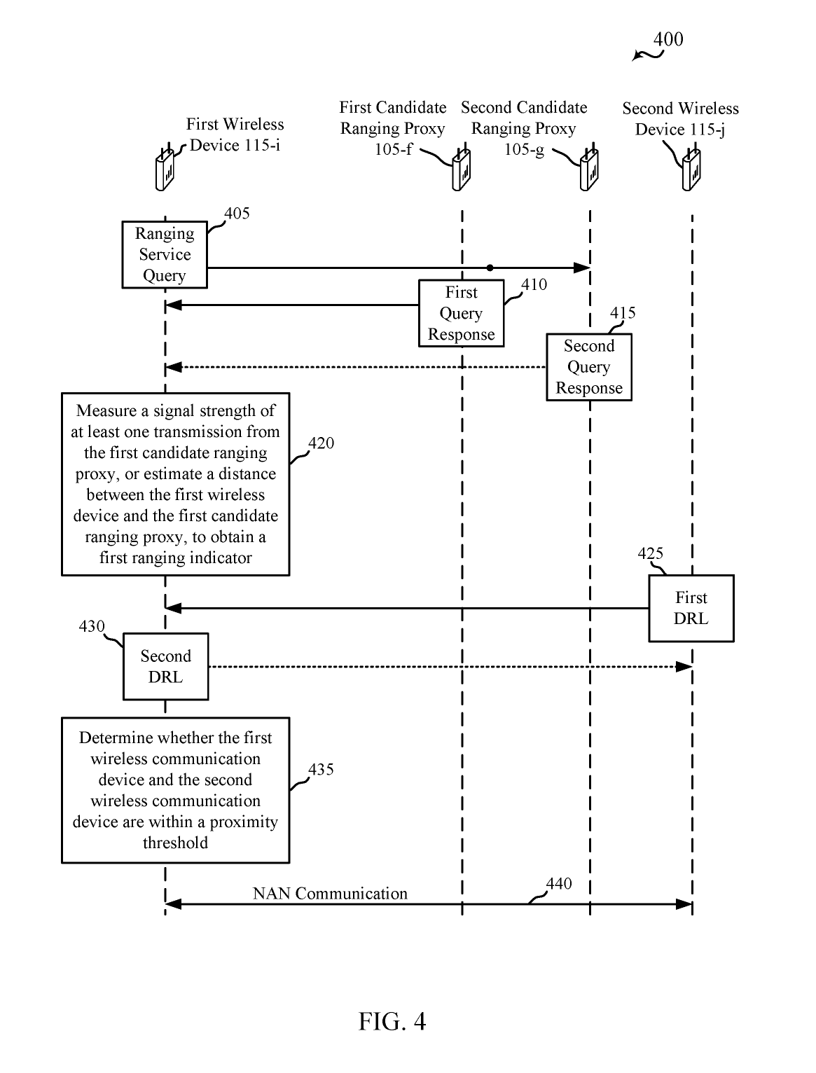

FIG. 4 is a swim lane diagram 400 illustrating the performance of ranging by a first wireless device 115-i, in accordance with various aspects of the present disclosure. In some examples, each of the first wireless device 115-i and a second wireless device 115-j may be an example of aspects of one or more of the wireless devices 115 described with reference to FIGS. 1-3. Similarly, each of a first candidate ranging proxy 105-f and a second candidate ranging proxy 105-g may be an example of aspects of one or more of the candidate ranging proxies 105, or aspects of one or more of the wireless devices 115 operating as a candidate ranging proxy, as described with reference to FIGS. 1-3.

The first wireless device 115-i may broadcast a ranging service query 405. The ranging service query 405 may be received by one or more candidate ranging devices, such as the first candidate ranging proxy 105-f and the second candidate ranging proxy 105-g. The ranging service query 405 may also be received by the second wireless device 115-j (not shown).

At 410, the first candidate ranging proxy 105-f may transmit a first query response 410 to the first wireless device 115-i. In some examples, the first query response 410 may be understood (e.g., by the first wireless device 115-i) to be a first ranging proxy indicator.

At 415, the second candidate ranging proxy 105-g may optionally transmit a second query response 415 to the first wireless device 115-i. In some examples, the second query response 415 may be understood (e.g., by the first wireless device 115-i) to be a second ranging proxy indicator.

At block 420, the first wireless device 115-i may identify a first ranging indicator based at least in part on the first query response 410, which may include a ranging proxy indicator received. The first query response 410 may indicate a proximity of the first wireless device 115-i to the first candidate ranging proxy 105-f. In some examples, identifying the first ranging indicator may include measuring a signal strength (e.g., a received signal strength indicator (RSSI) level) of at least one transmission received from the first candidate ranging proxy 105-f (e.g., a signal strength of the first query response 410, or signal strength or average signal strength of at least one transmission received from the first candidate ranging proxy 105-f). Measuring the signal strength of the at least one transmission may also include mapping the measured signal strength (or average measured signal strength) to one of a plurality of signal strength levels, as described with reference to FIG. 3.

At 425, the first wireless device 115-i may receive a first DRL 425. The first DRL 425 may include a second ranging indicator indicating a proximity of the second wireless device 115-j to the first candidate ranging proxy 105-f. The second ranging indicator may be identified by the second wireless device 115-j similarly to how the first ranging indicator is identified by the first wireless device 115-i. The first DRL 425 may be received directly from the second wireless device 115-j (as shown), or transmitted via one or more intermediate devices, such as the first candidate ranging proxy 105-f or the second candidate ranging proxy 105-g. The first DRL 425 may be received, in some embodiments, in a publish or subscribe frame of a NAN.

At 430, the first wireless device 115-i may optionally transmit a second DRL 430 to the second wireless device 115-j and/or other wireless devices. The second DRL 430 may include the first ranging indicator. The second DRL 430 may be transmitted directly to the second wireless device 115-j (as shown), or transmitted via one or more intermediate devices, such as the first candidate ranging proxy 105-f or the second candidate ranging proxy 105-g. The second DRL 430 may be transmitted, in some embodiments, in a publish or subscribe frame of a NAN.

At block 435, the first wireless device 115-i may determine whether the first wireless device 115-i and the second wireless device 115-j are within a proximity threshold. In some examples, the determination may be made similarly to how the first wireless device 115-g makes such a determination at block 330 in the swim lane diagram 300.

Upon identifying that the first wireless device 115-i and the second wireless device 115-j are within the proximity threshold, the first wireless device 115-i may establish wireless communication (e.g., NAN communication) with the second wireless device 115-j at 440.

In some embodiments of the ranging demonstrated by the swim lane diagram 400, the operation(s) at block 415 may include identifying a plurality of ranging indicators, with a set of the ranging indicators indicating proximities of the first wireless device 115-i to a plurality of candidate ranging proxies. For example, in addition to identifying the first ranging indicator, the first wireless device 115-i may identify a third ranging indicator based at least in part on the second ranging proxy indicator received in the second beacon frame at 410. The third ranging indicator may indicate a proximity of the first wireless device 115-i to the second candidate ranging proxy 105-g.

In some embodiments of the ranging demonstrated by the swim lane diagram 400, the first DRL and/or the second DRL may include a plurality of ranging indicators, as described with reference to FIG. 3. In some embodiments, the first wireless device 115-i may determine whether the first wireless device 115-i and the second wireless device 115-j are within a proximity threshold, at block 435, based at least in part on a plurality of ranging indicators included in the first DRL and the second DRL, as also described with reference to FIG. 3.

In some embodiments of the ranging demonstrated by the swim lane diagram 400, the operation(s) at block 420 may include estimating a distance between the first wireless device 115-i and the first candidate ranging proxy 105-f. In these embodiments, the first query response 410 received from the first candidate ranging proxy 105-f may indicate a time and channel for performing a distance ranging protocol. In some examples, the distance ranging protocol may include a distance ranging protocol such as a fine timing measurement (FTM) ranging protocol, in which a plurality of messages are exchanged between the first wireless device 115-i and the first candidate ranging proxy 105-f, beginning at the indicated time and on the indicated channel. In some examples, estimating the distance between the first wireless device 115-i and the second wireless device 115-j may include mapping the estimated distance to one of a plurality of distance ranges. For example, an estimated distance may be mapped to one of a plurality of distance ranges represented by a few bits (e.g., two or three bits). The operation(s) at block 415 may also include estimating a distance between the first wireless device 115-i and one or more other candidate ranging proxies (e.g., between the first wireless device 115-i and the second candidate ranging proxy 105-g).

When ranging indicators include estimated distances from wireless devices to candidate ranging proxies, the estimated distances may be used in different ways, at block 435, to determine whether the first wireless device 115-i and the second wireless device 115-j are within a proximity threshold. For example, for each candidate ranging proxy, p, for which an estimated distance from the first wireless device 115-i to the candidate ranging proxy is available (e.g., a Distance(Device1, p)), and for which an estimated distance from the second wireless device 115-j to the candidate ranging proxy is available (e.g., a Distance(Device2, p)), a sum D(p) may be calculated, where:

D(p)=Distance(Device1,p)+Distance(Device2,p)

The minimum of all sums D(p) calculated for the first wireless device 115-i and the second wireless device 115-j may be considered an upper bound on the distance between the first wireless device 115-i and the second wireless device 115-j. When the minimum of the sums D(p) satisfies a distance threshold (e.g., when D(p) is less than the distance threshold), the first wireless device 115-i and the second wireless device 115-j may be considered within the proximity threshold. When the minimum of the sums D(p) does not satisfy the distance threshold (e.g., when D(p) is greater than the distance threshold), the first wireless device 115-i and the second wireless device 115-j may be identified as being outside (i.e., not meeting) the proximity threshold.

As another example of using estimated distances to determine whether the first wireless device 115-i and the second wireless device 115-j are within the proximity threshold, when estimated distances are available from each of the first wireless device 115-i and the second wireless device 115-j, to three common candidate ranging proxies, the relative distance between the first wireless device 115-i and the second wireless device 115-j may be computed by performing trilateration (and the exact distance between the first wireless device 115-i and the second wireless device 115-j may be computed when the distance relationships between the common candidate ranging proxies are known).

When the ranging indicators identified or received in the swim lane diagram 400 include estimated distances, the first DRL 425 and/or the second DRL 430 may include a number of entries, with each entry including an identifier of a candidate ranging proxy (e.g., a master device address or a medium access control (MAC) address) associated with an estimated distance from a wireless device to the identified candidate ranging proxy. In some embodiments, each ranging indicator included in the first DRL 425 may be associated with at least one of: a timestamp or an expiration time.

In some embodiments of the swim lane diagram 200, 300, or 400 described with reference to FIG. 2, 3, or 4, a candidate ranging proxy 105 may be a master device, such as a wireless access point, or a non-master device, such as another wireless device 115.

In some examples, a single wireless device may perform various of the functions performed by the wireless devices 115 described with reference to FIGS. 1-4.

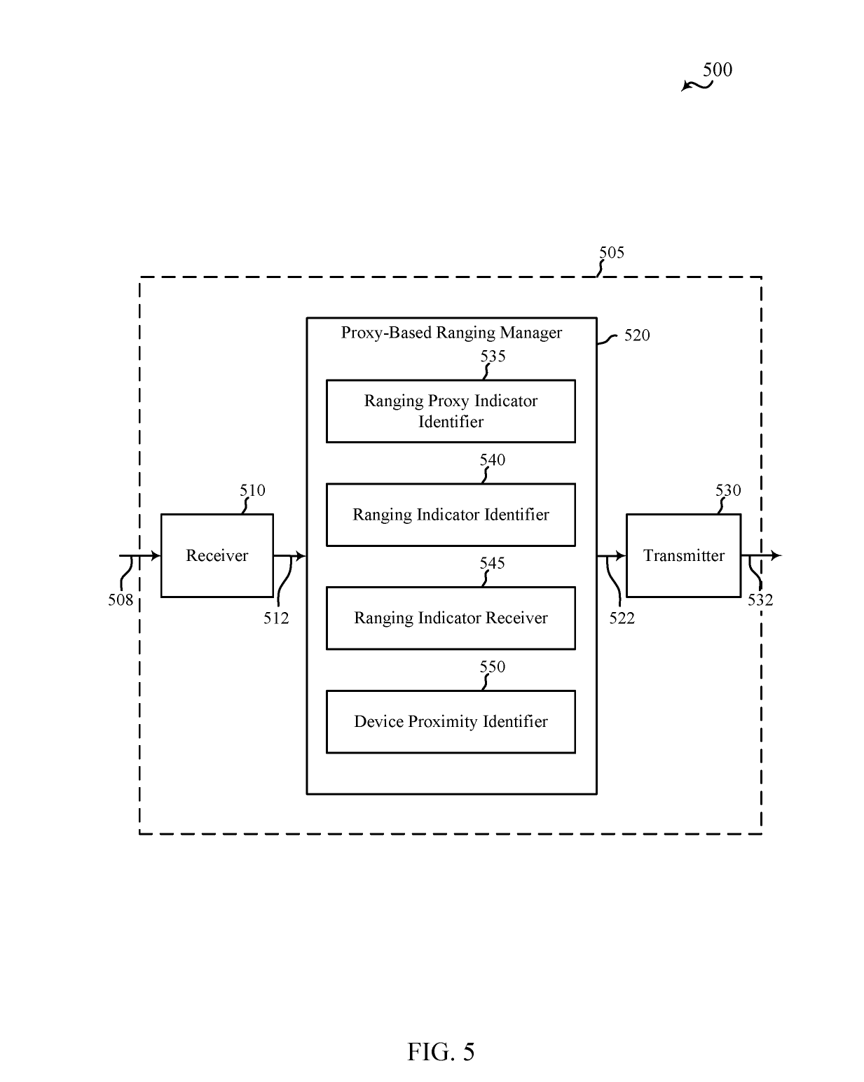

FIG. 5 shows a block diagram 500 of an apparatus 505 configured for performing ranging using one or more candidate ranging proxies, in accordance with various aspects of the present disclosure. In some examples, the apparatus 505 may be an example of aspects of one or more of the wireless devices 115 described with reference to FIGS. 1-4. The apparatus 505 may also be or include a processor (not shown). In some embodiments, the apparatus 505 may be configured to perform functions of the first wireless device 115-e described with reference to FIG. 2. The apparatus 505 may include a receiver 510, a proxy-based ranging manager 520, and/or a transmitter 530. Each of these components may be in communication with each other. The proxy-based ranging manager 520 may include a ranging proxy indicator identifier 535, a ranging indicator identifier 540, a ranging indicator receiver 545, and/or a device proximity identifier 550. The proxy-based ranging manager 520 may be an example of the proxy-based ranging manager 125 of FIG. 1.

The components of the apparatus 505 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits, or by other circuits or circuitry. In other examples, other types of integrated circuits may be used (e.g., Structured/Platform ASICs, Field Programmable Gate Arrays (FPGAs), a System on Chip (SoC), or other Semi-Custom ICs), which may be programmed in any manner known in the art. The functions of each component may also be implemented, in whole or in part, with instructions embodied in a memory, formatted to be executed by one or more general or application-specific processors.

In some examples, the receiver 510 may include at least one radio frequency (RF) receiver. The receiver 510 may be used to receive various types of data or control signals 508 (i.e., transmissions) over one or more communication links or channels of a wireless communication system, such as one or more communication links or channels of the wireless communication system 100 described with reference to FIG. 1. Signals 508 may include a ranging proxy indicator, a DRL signal, a beacon frame, a query response, NAN communications, etc. The receiver 510 may include a single antenna or a plurality of antennas.

The proxy-based ranging manager 520 may receive signals 512 from receiver 510 and pass signals 522 to transmitter 530. For instance, signals 512 may include a ranging proxy indicator, a DRL signal, a beacon frame, query response, a ranging indicator, etc. Signals 522 may include a NAN communication, a ranging proxy indicator, a ranging indicator, a query, a DRL, etc.

In some examples, the transmitter 530 may include at least one RF transmitter. The transmitter 530 may be used to transmit various types of data or control signals 532 (i.e., transmissions) over one or more communication links or channels of a wireless communication system, such as one or more communication links or channels of the wireless communication system 100 described with reference to FIG. 1. Signals 532 may include a ranging proxy indicator, a DRL signal, a beacon frame, a query response, NAN communications, etc. The transmitter 530 may include a single antenna or a plurality of antennas. In some embodiments, at least one antenna may be shared between the receiver 510 and transmitter 530.

The ranging proxy indicator identifier 535 may be used to receive a ranging proxy indicator from a candidate ranging proxy at a first wireless device (e.g., a wireless device including the apparatus 505).

The ranging indicator identifier 540 may be used to identify a first ranging indicator based at least in part on the ranging proxy indicator. The first ranging indicator may indicate a proximity of the first wireless device to the candidate ranging proxy.

The ranging indicator receiver 545 may be used to receive a second ranging indicator indicating a proximity of a second wireless device to the candidate ranging proxy.

The device proximity identifier 550 may be used to identify the first wireless device and the second wireless device being within a proximity threshold based at least in part on the first ranging indicator and the second ranging indicator.

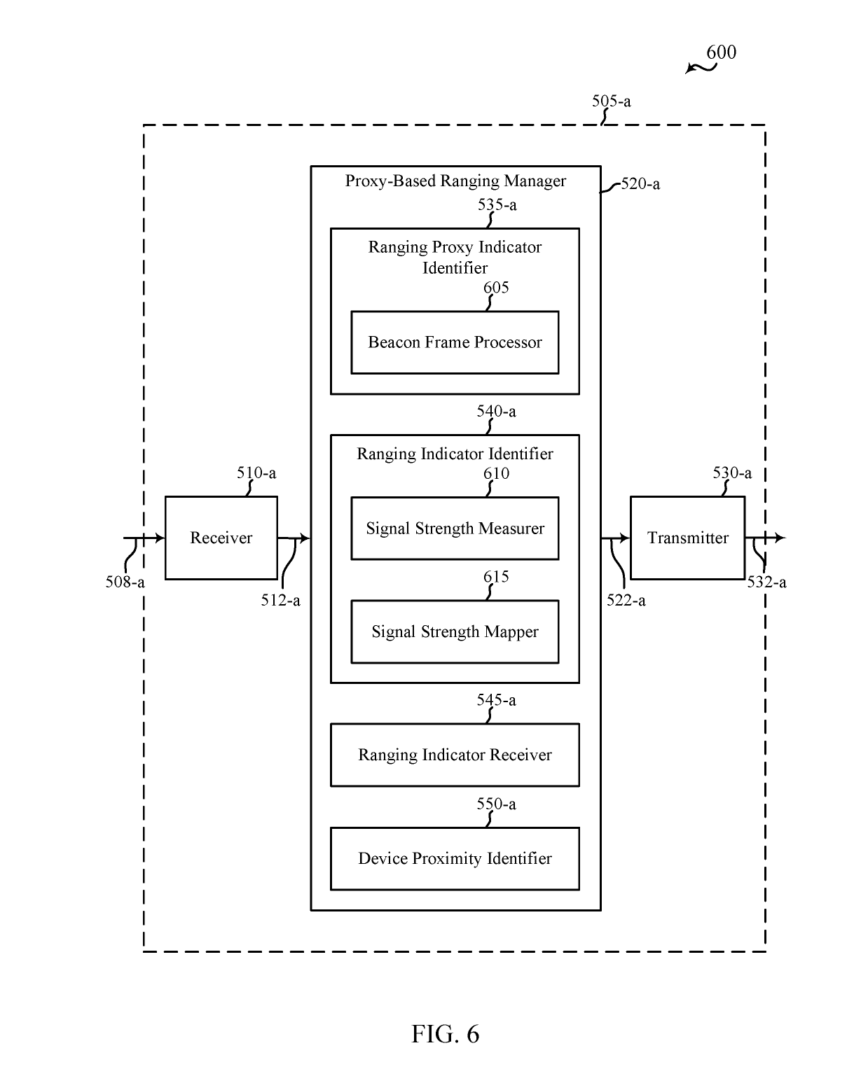

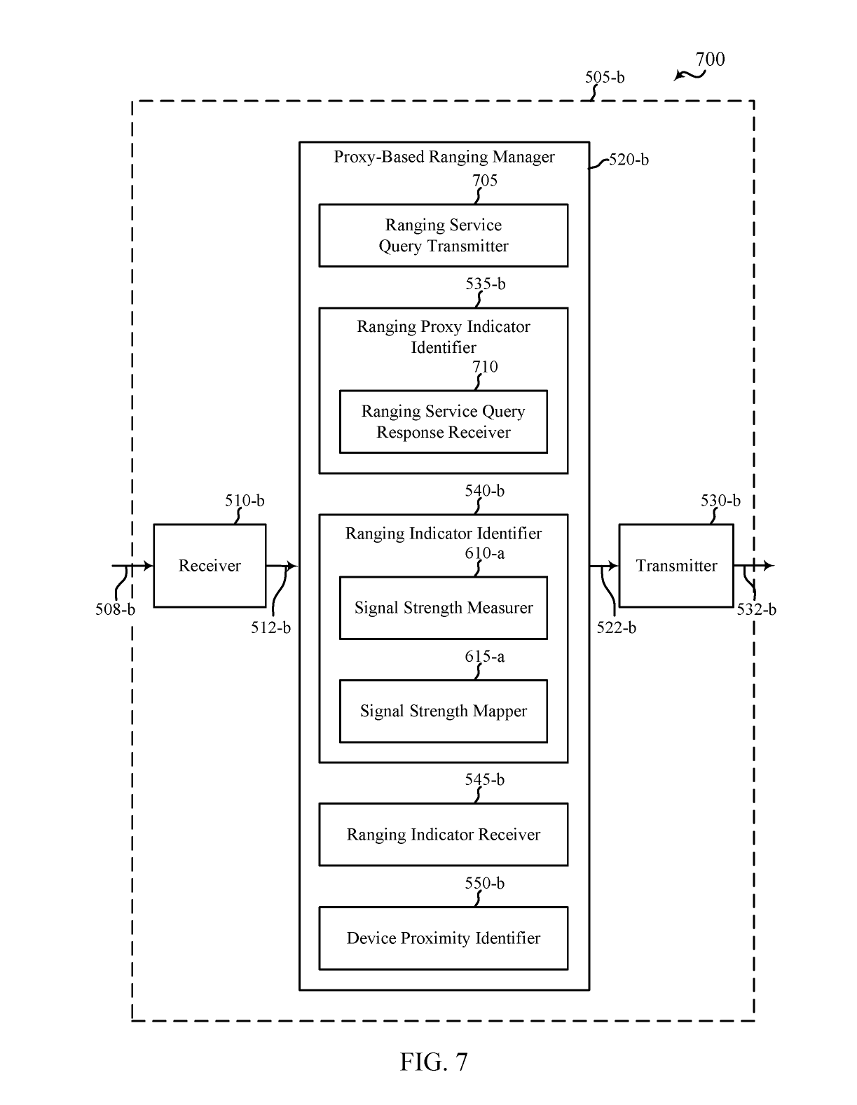

FIG. 6 shows a block diagram 600 of an apparatus 505-a configured for performing ranging using one or more candidate ranging proxies, in accordance with various aspects of the present disclosure. In some examples, the apparatus 505-a may be an example of aspects of one or more of the wireless devices 115 or apparatus 505 described with reference to FIGS. 1-5. The apparatus 505-a may also be or include a processor (not shown). In some embodiments, the apparatus 505-a may be configured to perform functions of the first wireless device 115-g described with reference to FIG. 3. The apparatus 505-a may include a receiver 510-a, a proxy-based ranging manager 520-a, and/or a transmitter 530-a, which may be examples of the corresponding components described with reference to FIG. 5 and may communicate signals 508-a, 512-a, 522-a and 532-a with one another, as described with reference to FIG. 5. Each of these components may be in communication with each other. The proxy-based ranging manager 520-a may include a ranging proxy indicator identifier 535-a, a ranging indicator identifier 540-a, a ranging indicator receiver 545-a, and/or a device proximity identifier 550-a. The proxy-based ranging manager 520-a may be an example of the proxy-based ranging manager 125 of FIG. 1 and/or the proxy-based ranging manager 520 of FIG. 5.

The components of the apparatus 505-a may, individually or collectively, be implemented using one or more ASICs adapted to perform some or all of the applicable functions in hardware. Alternatively, the functions may be performed by one or more other processing units (or cores), on one or more integrated circuits, or by other circuits or circuitry. In other examples, other types of integrated circuits may be used (e.g., Structured/Platform ASICs, FPGAs, a SoC, or other Semi-Custom ICs), which may be programmed in any manner known in the art. The functions of each component may also be implemented, in whole or in part, with instructions embodied in a memory, formatted to be executed by one or more general or application-specific processors.

The ranging proxy indicator identifier 535-a may be used to receive a ranging proxy indicator from a candidate ranging proxy at a first wireless device (e.g., a wireless device including the apparatus 505-a). The ranging proxy indicator may be received in a beacon frame transmitted by the candidate ranging proxy, and may be identified within the beacon frame using a beacon frame processor 605 of the ranging proxy indicator identifier 535-a.

The ranging indicator identifier 540-a may be used to identify a first ranging indicator based at least in part on the ranging proxy indicator. The first ranging indicator may indicate a proximity of the first wireless device to the candidate ranging proxy. In some examples, the ranging indicator identifier 540-a may include a signal strength measurer 610 or a signal strength mapper 615. The signal strength measurer 610 may be used to measure a signal strength of the beacon frame to identify the first ranging indicator. In some examples, the signal strength measurer 610 may measure the signal strength of the beacon frame by measuring an RSSI level of the beacon frame. In some examples, the signal strength mapper 615 may be used to map the signal strength to one of a plurality of signal strength levels.

The ranging indicator receiver 545-a may be used to receive a second ranging indicator indicating a proximity of a second wireless device to the candidate ranging proxy. In some embodiments, the second ranging indicator may be received in a DRL including an identifier of the candidate ranging proxy associated with the second ranging indicator.

The device proximity identifier 550-a may be used to identify the first wireless device and the second wireless device being within a proximity threshold based at least in part on the first ranging indicator and the second ranging indicator.

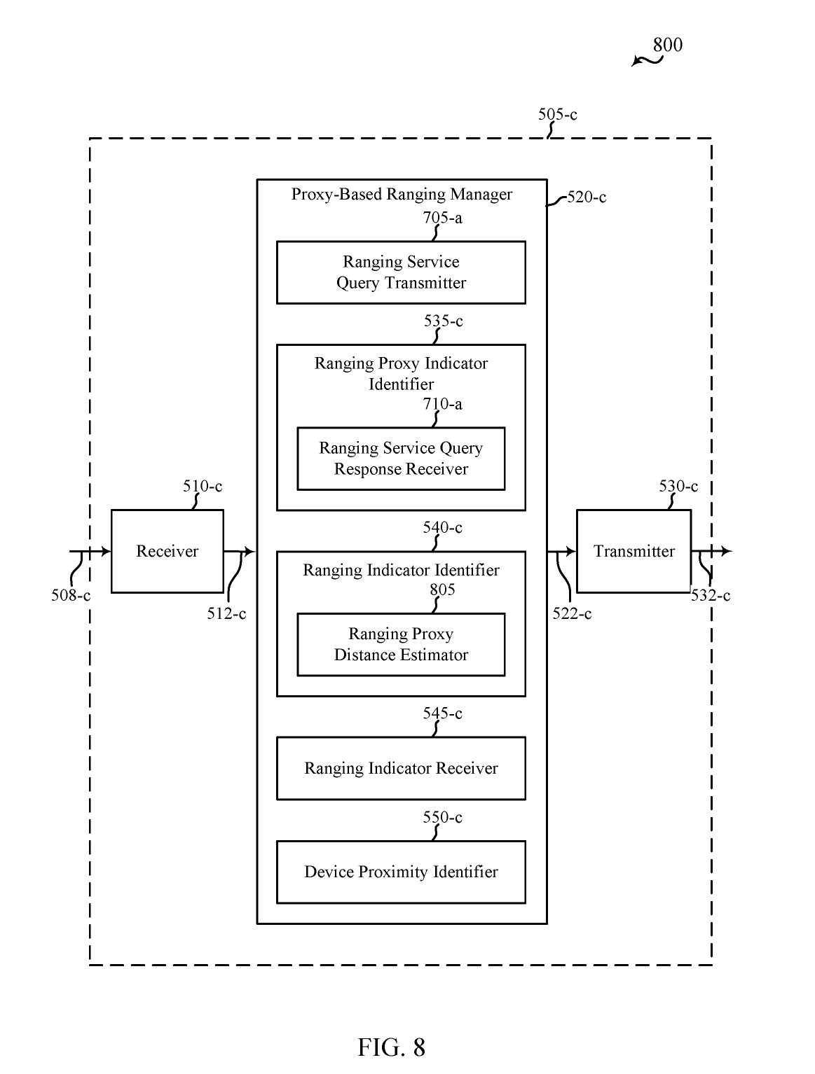

FIG. 7 shows a block diagram 700 of an apparatus 505-b configured for performing ranging using one or more candidate ranging proxies, in accordance with various aspects of the present disclosure. In some examples, the apparatus 505-b may be an example of aspects of one or more of the wireless devices 115 or apparatuses 505 described with reference to FIGS. 1-6. The apparatus 505-b may also be or include a processor (not shown). In some embodiments, the apparatus 505-b may be configured to perform functions of the first wireless device 115-i described with reference to FIG. 4. The apparatus 505-b may include a receiver 510-b, a proxy-based ranging manager 520-b, and/or a transmitter 530-b, which may be examples of the corresponding components described with reference to FIG. 5 and may communicate signals 508-b, 512-b, 522-b and 532-b with one another, as described with reference to FIG. 5. Each of these components may be in communication with each other. The proxy-based ranging manager 520-b may include a ranging service query transmitter 705, a ranging proxy indicator identifier 535-b, a ranging indicator identifier 540-b, a ranging indicator receiver 545-b, and/or a device proximity identifier 550-b. The proxy-based ranging manager 520-b may be an example of the proxy-based ranging manager 125 of FIG. 1 and/or the proxy-based ranging manager 520 of FIG. 5, and/or the proxy-based ranging manager 520-a of FIG. 6.

The components of the apparatus 505-b may, individually or collectively, be implemented using one or more ASICs adapted to perform some or all of the applicable functions in hardware. Alternatively, the functions may be performed by one or more other processing units (or cores), on one or more integrated circuits, or by other circuits or circuitry. In other examples, other types of integrated circuits may be used (e.g., Structured/Platform ASICs, FPGAs, a SoC, or other Semi-Custom ICs), which may be programmed in any manner known in the art. The functions of each component may also be implemented, in whole or in part, with instructions embodied in a memory, formatted to be executed by one or more general or application-specific processors.

The ranging service query transmitter 705 may be used to broadcast a query for a ranging service.

The ranging proxy indicator identifier 535-b may be used to receive a ranging proxy indicator from a candidate ranging proxy at a first wireless device (e.g., a wireless device including the apparatus 505-b). The ranging proxy indicator may be received in response to the query by the ranging service query transmitter 705, and in some cases may be the response to the query (e.g., the ranging proxy indicator may be implicit). In some examples, the received response may be processed, or the ranging proxy indicator may be identified, using a ranging service query response receiver 710 of the ranging proxy indicator identifier 535-b.

The ranging indicator identifier 540-b may be used to identify a first ranging indicator based at least in part on the ranging proxy indicator. The first ranging indicator may indicate a proximity of the first wireless device to the candidate ranging proxy. In some examples, the ranging indicator identifier 540-b may include a signal strength measurer 610-a or a signal strength mapper 615-a. The signal strength measurer 610-a may be used to measure a signal strength of at least one transmission received from the candidate ranging proxy (e.g., the response to the query) to identify the first ranging indicator. In some examples, the signal strength measurer 610-a may measure the signal strength of the at least one transmission by measuring an RSSI level of the at least one transmission. In some examples, the signal strength mapper 615-a may be used to map the signal strength to one of a plurality of signal strength levels.

The ranging indicator receiver 545-b may be used to receive a second ranging indicator indicating a proximity of a second wireless device to the candidate ranging proxy. In some embodiments, the second ranging indicator may be received in a DRL including an identifier of the candidate ranging proxy associated with the second ranging indicator.

The device proximity identifier 550-b may be used to identify the first wireless device and the second wireless device being within a proximity threshold based at least in part on the first ranging indicator and the second ranging indicator.

FIG. 8 shows a block diagram 800 of an apparatus 505-c configured for performing ranging using one or more candidate ranging proxies, in accordance with various aspects of the present disclosure. In some examples, the apparatus 505-c may be an example of aspects of one or more of the wireless devices 115 or apparatuses 505 described with reference to FIGS. 1-7. The apparatus 505-c may also be or include a processor (not shown). In some embodiments, the apparatus 505-c may be configured to perform functions of the first wireless device 115-i described with reference to FIG. 4. The apparatus 505-c may include a receiver 510-c, a proxy-based ranging manager 520-c, and/or a transmitter 530-c, which may be examples of the corresponding components described with reference to FIG. 5 and may communicate signals 508-c, 512-c, 522-c and 532-c with one another, as described with reference to FIG. 5. Each of these components may be in communication with each other. The proxy-based ranging manager 520-c may include a ranging service query transmitter 705-a, a ranging proxy indicator identifier 535-c, a ranging indicator identifier 540-c, a ranging indicator receiver 545-c, and/or a device proximity identifier 550-c. The proxy-based ranging manager 520-c may be an example of the proxy-based ranging manager 125 of FIG. 1 and/or the proxy-based ranging manager 520 of FIG. 5, and/or the proxy-based ranging manager 520-a of FIG. 6, and/or the proxy-based ranging manager 520-b of FIG. 7.

The components of the apparatus 505-c may, individually or collectively, be implemented using one or more ASICs adapted to perform some or all of the applicable functions in hardware. Alternatively, the functions may be performed by one or more other processing units (or cores), on one or more integrated circuits, or by other circuits or circuitry. In other examples, other types of integrated circuits may be used (e.g., Structured/Platform ASICs, FPGAs, a SoC, or other Semi-Custom ICs), which may be programmed in any manner known in the art. The functions of each component may also be implemented, in whole or in part, with instructions embodied in a memory, formatted to be executed by one or more general or application-specific processors.

The ranging service query transmitter 705-a may be used to broadcast a query for a ranging service.

The ranging proxy indicator identifier 535-c may be used to receive a ranging proxy indicator from a candidate ranging proxy at a first wireless device (e.g., a wireless device including the apparatus 505-c). The ranging proxy indicator may be received in response to the query by the ranging service query transmitter 705-a, and in some cases may be the response to the query (e.g., the ranging proxy indicator may be implicit). In some examples, the received response may be processed, or the ranging proxy indicator may be identified, using a ranging service query response receiver 710-a of the ranging proxy indicator identifier 535-c.

The ranging indicator identifier 540-c may be used to identify a first ranging indicator based at least in part on the ranging proxy indicator. The first ranging indicator may indicate a proximity of the first wireless device to the candidate ranging proxy. In some examples, the ranging indicator identifier 540-c may include a ranging proxy distance estimator 805. The ranging proxy distance estimator 805 may be used to estimate a distance between the first wireless device and the candidate ranging proxy to identify the first ranging indicator. In some examples, estimating the distance between the first wireless device and the candidate ranging proxy may include performing a distance ranging protocol, such as an FTM ranging protocol, in which a plurality of messages are exchanged between the first wireless device and the candidate ranging proxy. In some examples, the ranging indicator identifier 540-c may be used to map the estimated distance to one of a plurality of distance ranges.

The ranging indicator receiver 545-b may be used to receive a second ranging indicator indicating a proximity of a second wireless device to the candidate ranging proxy. In some embodiments, the second ranging indicator may be received in a DRL including an identifier of the candidate ranging proxy associated with the second ranging indicator.

The device proximity identifier 550-b may be used to identify the first wireless device and the second wireless device being within a proximity threshold based at least in part on the first ranging indicator and the second ranging indicator.

In some examples, aspects of two or more of the apparatuses 505 described with reference to FIG. 5, 6, 7, or 8 may be combined.

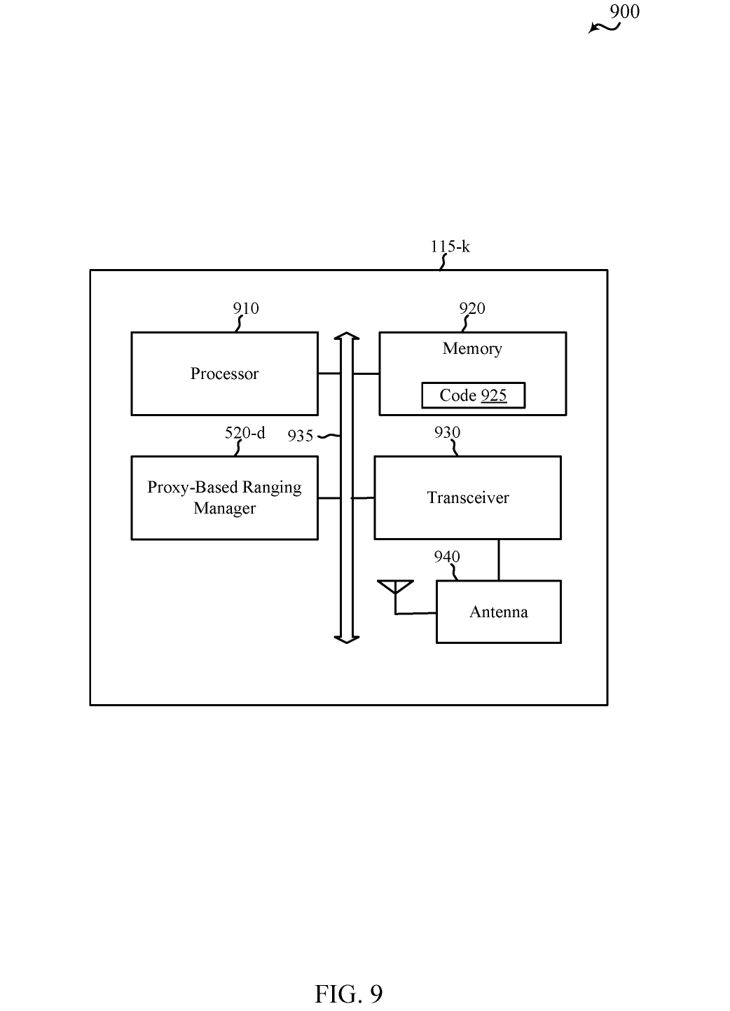

Turning to FIG. 9, a diagram 900 is shown that illustrates a wireless device 115-k configured for performing ranging using one or more candidate ranging proxies, in accordance with various aspects of the present disclosure. The wireless device 115-k may have an internal power supply (not shown), such as a small battery, to facilitate mobile operation. In some examples, the wireless device 115-k may be an example of aspects of one or more of the wireless devices 115 or apparatuses described with reference to FIGS. 1-8.

The wireless device 115-k may include a processor 910, a memory 920, a transceiver 930, an antenna 940, and a proxy-based ranging manager 520-d. The proxy-based ranging manager 520-d may be an example of aspects of the proxy-based ranging manager 125 of FIG. 1 and/or the proxy-based ranging managers 520 described with reference to FIGS. 5-8. Each of these components may be in communication with each other, directly or indirectly, over at least one bus 935.

The memory 920 may include random access memory (RAM) or read-only memory (ROM). The memory 920 may store computer-readable, computer-executable code 925 containing instructions that are configured to, when executed, cause the processor 910 to perform various of the functions described herein for performing ranging. Alternatively, the code 925 may not be directly executable by the processor 910 but be configured (e.g., when compiled and executed) to cause the wireless device 115-k to perform various of the functions described herein.

The processor 910 may include an intelligent hardware device, e.g., a central processing unit (CPU), a microcontroller, an ASIC, an FPGA, a SoC, etc. The processor 910 may process information received through the transceiver 930 from the antenna 940 and/or information to be transmitted through the transceiver 930 for transmission via the antenna 940. The processor 910 may handle, alone or in connection with the proxy-based ranging manager 520-d, various aspects of performing ranging using one or more candidate ranging proxies.

The transceiver 930 may be configured to communicate bi-directionally with various of the devices described with reference to FIGS. 1-8, including master and non-master devices, access points (APs), candidate ranging proxies 105, and other wireless devices 115. In some embodiments, the transceiver 930 may be implemented as at least one transmitter and at least one separate receiver (including, e.g., the receiver 510 or transmitter 530 described with any of FIGS. 5-8). The transceiver 930 may include a modem configured to modulate packets and provide the modulated packets to the antenna 940 for transmission, and to demodulate packets received from the antenna 940. While the wireless device 115-k may include a single transceiver and antenna in some embodiments, the wireless device 115-k may include multiple transceivers or antennas in other embodiments.

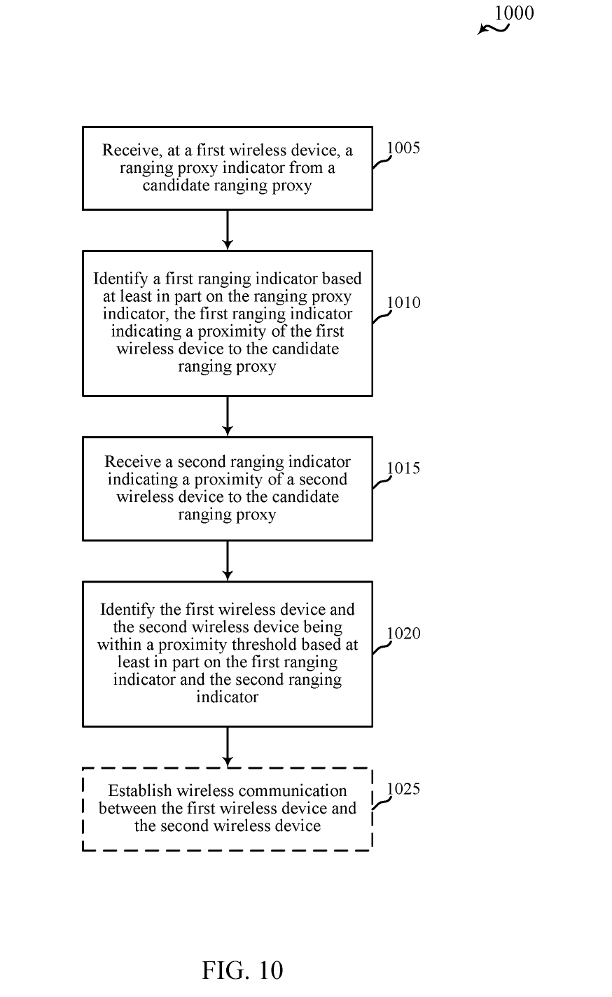

The components of the wireless device 115-k may be configured to implement various of the aspects described above with reference to FIGS. 1-8, and those aspects may not be repeated here for the sake of brevity. Moreover, the components of the wireless device 115-k may be configured to implement aspects discussed below with respect to FIGS. 10-12, and those aspects may also not be repeated here for the sake of brevity.

FIG. 10 is a flow chart illustrating an example of a method 1000 for wireless communication, in accordance with various aspects of the present disclosure. For clarity, the method 1000 is described below with reference to aspects of one or more of the wireless devices 115 or apparatuses 505 described with reference to FIGS. 1-9. In some examples, a wireless device may execute one or more sets of codes to control the functional elements of the wireless device to perform the functions described below. Additionally or alternatively, the wireless device may perform one or more of the functions described below using special-purpose hardware.

At block 1005, the method 1000 may include receiving a ranging proxy indicator from a candidate ranging proxy at a first wireless device. The operation(s) at block 1005 may be performed using the proxy-based ranging manager 125 of FIG. 1, the proxy-based ranging manager 520 described with reference to FIGS. 5-9, or the ranging proxy indicator identifier 535 described with reference to FIGS. 5-8.

At block 1010, the method 1000 may include identifying a first ranging indicator based at least in part on the ranging proxy indicator. The first ranging indicator may indicate a proximity of the first wireless device to the candidate ranging proxy. The operation(s) at block 1010 may be performed using the proxy-based ranging manager 520 described with reference to FIGS. 5-9 or the ranging indicator identifier 540 described with reference to FIGS. 5-8.

At block 1015, the method 1000 may include receiving a second ranging indicator indicating a proximity of a second wireless device to the candidate ranging proxy. The operation(s) at block 1015 may be performed using the proxy-based ranging manager 520 described with reference to FIGS. 5-9 or the ranging indicator receiver 545 described with reference to FIGS. 5-8.

At block 1020, the method 1000 may include identifying the first wireless device and the second wireless device being within a proximity threshold based at least in part on the first ranging indicator and the second ranging indicator. The operation(s) at block 1020 may be performed using the proxy-based ranging manager 520 described with reference to FIGS. 5-9 or the device proximity identifier 550 described with reference to FIGS. 5-8.

At block 1025, the method 1000 may optionally include establishing wireless communication (e.g., NAN communication) between the first wireless device and the second wireless device. The operation(s) at block 1025 may be performed using the proxy-based ranging manager 520-d described with reference to FIGS. 5-9.

Thus, the method 1000 may provide for wireless communication. It should be noted that the method 1000 is just one implementation and that the operations of the method 1000 may be rearranged or otherwise modified such that other implementations are possible. In some embodiments, the first wireless device, second wireless device, and candidate ranging proxy referenced in the method 1000 may be configured to perform functions of the respective first wireless device 115-e, second wireless device 115-f, and candidate ranging proxy 105-c described with reference to FIG. 2.

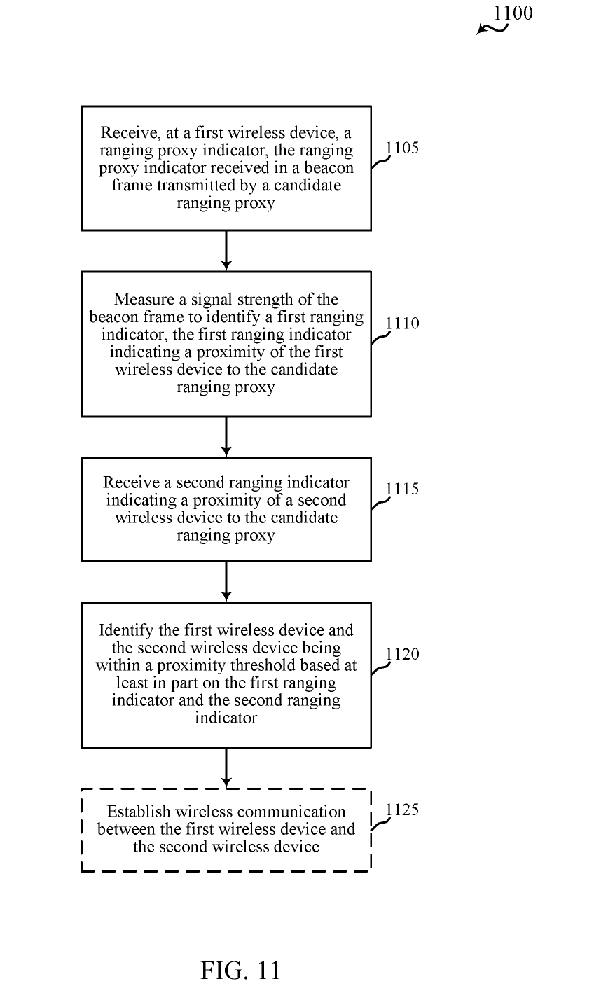

FIG. 11 is a flow chart illustrating an example of a method 1100 for wireless communication, in accordance with various aspects of the present disclosure. For clarity, the method 1100 is described below with reference to aspects of one or more of the wireless devices 115 or apparatuses 505 described with reference to FIGS. 1-9. In some examples, a wireless device may execute one or more sets of codes to control the functional elements of the wireless device to perform the functions described below. Additionally or alternatively, the wireless device may perform one or more of the functions described below using special-purpose hardware.

At block 1105, the method 1100 may include receiving a ranging proxy indicator from a candidate ranging proxy at a first wireless device. The ranging proxy indicator may be received in a beacon frame transmitted by the candidate ranging proxy. The operation(s) at block 1105 may be performed using the proxy-based ranging manager 125 of FIG. 1, the proxy-based ranging manager 520 described with reference to FIGS. 5-9, the ranging proxy indicator identifier 535 described with reference to FIGS. 5-8, or the beacon frame processor 605 described with reference to FIG. 6.

At block 1110, the method 1100 may include identifying a first ranging indicator based at least in part on the ranging proxy indicator. The first ranging indicator may indicate a proximity of the first wireless device to the candidate ranging proxy. In some examples, the operation(s) at block 1110 may include measuring a signal strength of the beacon frame to identify the first ranging indicator. In some examples, measuring the signal strength of the beacon frame may include measuring an RSSI level of the beacon frame. In some examples, the operation(s) at block 1110 may further include mapping the signal strength to one of a plurality of signal strength levels. The operation(s) at block 1110 may be performed using the proxy-based ranging manager 520 described with reference to FIGS. 5-9, the ranging indicator identifier 540 described with reference to FIGS. 5-8, or the signal strength measurer 610 or signal strength mapper 615 described with reference to FIG. 6 or 7.

At block 1115, the method 1100 may include receiving a second ranging indicator indicating a proximity of a second wireless device to the candidate ranging proxy. In some embodiments, the second ranging indicator may be received in a DRL including an identifier of the candidate ranging proxy associated with the second ranging indicator. The operation(s) at block 1115 may be performed using the proxy-based ranging manager 520 described with reference to FIGS. 5-9 or the ranging indicator receiver 545 described with reference to FIGS. 5-8.

At block 1120, the method 1100 may include identifying the first wireless device and the second wireless device being within a proximity threshold based at least in part on the first ranging indicator and the second ranging indicator. The operation(s) at block 1120 may be performed using the proxy-based ranging manager 520 described with reference to FIGS. 5-9 or the device proximity identifier 550 described with reference to FIGS. 5-8.

At block 1125, the method 1100 may optionally include establishing wireless communication (e.g., NAN communication) between the first wireless device and the second wireless device. The operation(s) at block 1125 may be performed using the proxy-based ranging manager 520-d described with reference to FIGS. 5-9.

Thus, the method 1100 may provide for wireless communication. It should be noted that the method 1100 is just one implementation and that the operations of the method 1100 may be rearranged or otherwise modified such that other implementations are possible. In some embodiments, the first wireless device, second wireless device, and candidate ranging proxy referenced in the method 1100 may be configured to perform functions of the respective first wireless device 115-g, second wireless device 115-h, and first candidate ranging proxy 105-d described with reference to FIG. 3.

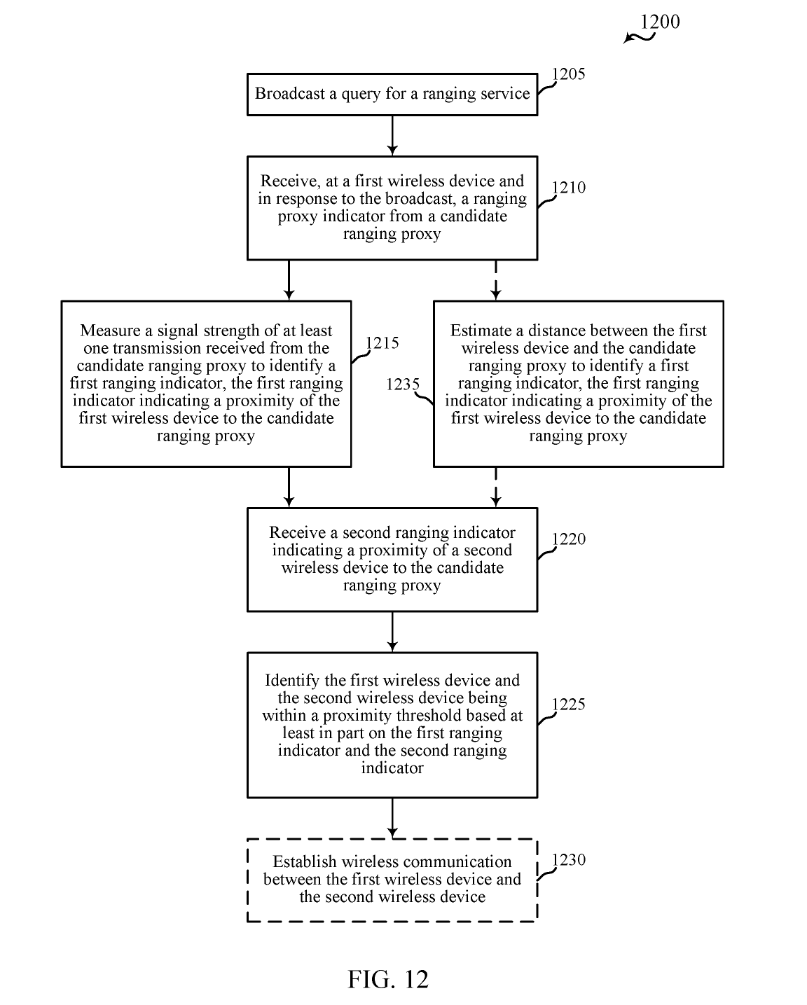

FIG. 12 is a flow chart illustrating an example of a method 1200 for wireless communication, in accordance with various aspects of the present disclosure. For clarity, the method 1200 is described below with reference to aspects of one or more of the wireless devices 115 or apparatuses 505 described with reference to FIGS. 1-9. In some examples, a wireless device may execute one or more sets of codes to control the functional elements of the wireless device to perform the functions described below. Additionally or alternatively, the wireless device may perform one or more of the functions described below using special-purpose hardware.

At block 1205, the method 1200 may include broadcasting a query for a ranging service. The operation(s) at block 1205 may be performed using the proxy-based ranging manager 125 described with reference to FIG. 1, the proxy-based ranging manager 520 described with reference to FIGS. 5-9 or the ranging service query transmitter 705 described with reference to FIG. 7 or 8.

At block 1210, the method 1200 may include receiving, at a first wireless device and in response to the query at block 1205, a ranging proxy indicator from a candidate ranging proxy. The operation(s) at block 1210 may be performed using the proxy-based ranging manager 520 described with reference to FIGS. 5-9, the ranging proxy indicator identifier 535 described with reference to FIGS. 5-8, or the ranging service query response receiver 710 described with reference to FIG. 7 or 8.

At block 1215, the method 1200 may include identifying a first ranging indicator based at least in part on the ranging proxy indicator. The first ranging indicator may indicate a proximity of the first wireless device to the candidate ranging proxy. In some examples, the operation(s) at block 1215 may include measuring a signal strength of at least one transmission received from the candidate ranging proxy to identify the first ranging indicator. In some examples, measuring the signal strength of the at least one transmission may include measuring an RSSI level of the at least one transmission. In some examples, the operation(s) at block 1215 may include mapping the signal strength to one of a plurality of signal strength levels. The operation(s) at block 1215 may be performed using the proxy-based ranging manager 520 described with reference to FIGS. 5-9, the ranging indicator identifier 540 described with reference to FIGS. 5-8, or the signal strength measurer 610 or signal strength mapper 615 described with reference to FIG. 6 or 7.

At block 1220, the method 1200 may include receiving a second ranging indicator indicating a proximity of a second wireless device to the candidate ranging proxy. The operation(s) at block 1220 may be performed using the proxy-based ranging manager 520 described with reference to FIGS. 5-9 or the ranging indicator receiver 545 described with reference to FIGS. 5-8.

At block 1225, the method 1200 may include identifying the first wireless device and the second wireless device being within a proximity threshold based at least in part on the first ranging indicator and the second ranging indicator. The operation(s) at block 1225 may be performed using the proxy-based ranging manager 520 described with reference to FIGS. 5-9 or the device proximity identifier 550 described with reference to FIGS. 5-8.

At block 1230, the method 1200 may optionally include establishing wireless communication (e.g., NAN communication) between the first wireless device and the second wireless device. The operation(s) at block 1230 may be performed using the proxy-based ranging manager 520-d described with reference to FIGS. 5-9.

In an alternative embodiment of the method 1200, the method 1200 may further perform the operation(s) at block 1235, or perform the operation(s) at block 1235 instead of the operation(s) at block 1215. At block 1235, the method 1200 may include identifying a first ranging indicator based at least in part on the ranging proxy indicator. In some examples, the operation(s) at block 1235 may include estimating a distance between the first wireless device and the candidate ranging proxy to identify the first ranging indicator. Estimating the distance between the first wireless device and the candidate ranging proxy may include performing a distance ranging protocol, such as an FTM ranging protocol, in which a plurality of messages are exchanged between the first wireless device and the candidate ranging proxy. In some examples, the operation(s) at block 1235 may include mapping the estimated distance to one of a plurality of distance ranges. The operation(s) at block 1235 may be performed using the proxy-based ranging manager 520 described with reference to FIGS. 5-9, the ranging indicator identifier 540 described with reference to FIGS. 5-8, or the ranging proxy distance estimator 805 described with reference to FIG. 8.

Thus, the method 1200 may provide for wireless communication. It should be noted that the method 1200 is just one implementation and that the operations of the method 1200 may be rearranged or otherwise modified such that other implementations are possible. In some embodiments, the first wireless device, second wireless device, and candidate ranging proxy referenced in the method 1200 may be configured to perform functions of the respective first wireless device 115-i, second wireless device 115-j, and first candidate ranging proxy 105-f described with reference to FIG. 4.

In some examples, aspects of two or more of the methods 1000, 1100, or 1200 described with reference to FIG. 10, 11, or 12 may be combined.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
receiving, at a first wireless device, a ranging proxy indicator from a candidate ranging proxy;
identifying a first ranging indicator based at least in part on the ranging proxy indicator, the first ranging indicator indicating a proximity of the first wireless device to the candidate ranging proxy;
receiving a second ranging indicator indicating a proximity of a second wireless device to the candidate ranging proxy; and
identifying the first wireless device and the second wireless device being within a proximity threshold based at least in part on the first ranging indicator and the second ranging indicator.

2. The method of claim 1, wherein the ranging proxy indicator comprises at least one of: a mobility indicator, or a power indicator, or a bandwidth indicator, or an indicator of an availability to provide a ranging service, or a list of wireless devices for which the candidate ranging proxy has provided a ranging service or previously ranged with, or a list of ranging indicators, or a combination thereof.

3. The method of claim 2, wherein entries in the list of wireless devices for which the candidate ranging proxy has provided a ranging service or previously ranged with are associated with respective timing information.

4. The method of claim 2, further comprising:
determining, based at least in part on the ranging proxy indicator, whether to range with at least one of: the candidate ranging proxy or a wireless device identified by the ranging proxy indicator.

5. The method of claim 1, further comprising:
receiving the ranging proxy indicator in a beacon frame transmitted by the candidate ranging proxy.

6. The method of claim 5, wherein identifying the first ranging indicator comprises:
measuring a signal strength of the beacon frame to identify the first ranging indicator.

7. The method of claim 6, wherein measuring the signal strength of the beacon frame comprises measuring a received signal strength indicator (RSSI) level of the beacon frame.

8. The method of claim 6, further comprising:
mapping the signal strength to one of a plurality of signal strength levels.

9. The method of claim 1, further comprising:
broadcasting a query for a ranging service; and
receiving the ranging proxy indicator from the candidate ranging proxy in response to the query.

10. The method of claim 9, wherein identifying the first ranging indicator comprises:
measuring a signal strength of at least one transmission received from the candidate ranging proxy to identify the first ranging indicator.

11. The method of claim 1, wherein identifying the first ranging indicator comprises:
estimating a distance between the first wireless device and the candidate ranging proxy to identify the first ranging indicator.

12. The method of claim 11, further comprising:
exchanging messages between the first wireless device and the candidate ranging proxy to estimate the distance between the first wireless device and the candidate ranging proxy.

13. The method of claim 11, further comprising:
performing a fine timing measurement (FTM) ranging protocol to estimate the distance between the first wireless device and the candidate ranging proxy.

14. The method of claim 1, wherein determining the first wireless device and the second wireless device are within the proximity threshold comprises:
performing trilateration based at least in part on a plurality of ranging indicators associated with identifiers of a plurality of candidate ranging proxies.

15. The method of claim 1, wherein the second ranging indicator is associated with at least one of: a timestamp or an expiration time.

16. An apparatus for wireless communication, comprising:
a ranging proxy indicator identifier to receive, at a first wireless device, a ranging proxy indicator from a candidate ranging proxy;
a ranging indicator identifier to identify a first ranging indicator based at least in part on the ranging proxy indicator, the first ranging indicator indicating a proximity of the first wireless device to the candidate ranging proxy;
a ranging indicator receiver to receive a second ranging indicator indicating a proximity of a second wireless device to the candidate ranging proxy; and
a device proximity identifier to identify the first wireless device and the second wireless device being within a proximity threshold based at least in part on the first ranging indicator and the second ranging indicator.

17. The apparatus of claim 16, wherein the ranging proxy indicator comprises at least one of: a mobility indicator, or a power indicator, or a bandwidth indicator, or an indicator of an availability to provide a ranging service, or a list of wireless devices for which the candidate ranging proxy has provided a ranging service or previously ranged with, or a list of ranging indicators, or a combination thereof.

18. The apparatus of claim 17, wherein entries in the list of wireless devices for which the candidate ranging proxy has provided a ranging service or previously ranged with are associated with respective timing information.

19. The apparatus of claim 16, wherein the ranging proxy indicator identifier comprises a beacon frame processor to receive the ranging proxy indicator in a beacon frame transmitted by the candidate ranging proxy.

20. The apparatus of claim 19, wherein the ranging indicator identifier comprises a signal strength measurer to measure a signal strength of the beacon frame to identify the first ranging indicator.

21. The apparatus of claim 16, further comprising:
a ranging service query transmitter to broadcast a query for a ranging service;
wherein the ranging proxy indicator identifier comprises a ranging service query response receiver to receive the ranging proxy indicator from the candidate ranging proxy in response to the query.

22. The apparatus of claim 16, wherein the ranging indicator identifier comprises a ranging proxy distance estimator to estimate a distance between the first wireless device and the candidate ranging proxy to identify the first ranging indicator.

23. An apparatus for wireless communication, comprising:
a processor;
memory in electronic communication with the processor; and
instructions stored in the memory, the instructions being executable by the processor to:
receive a ranging proxy indicator from a candidate ranging proxy;
identify a first ranging indicator based at least in part on the ranging proxy indicator, the first ranging indicator indicating a proximity of the apparatus to the candidate ranging proxy;
receive a second ranging indicator indicating a proximity of a second apparatus to the candidate ranging proxy; and
identify the apparatus and the second apparatus being within a proximity threshold based at least in part on the first ranging indicator and the second ranging indicator.

24. The apparatus of claim 23, wherein the ranging proxy indicator comprises at least one of: a mobility indicator, or a power indicator, or a bandwidth indicator, or an indicator of an availability to provide a ranging service, or a list of wireless devices for which the candidate ranging proxy has provided a ranging service or previously ranged with, or a list of ranging indicators, or a combination thereof.

25. The apparatus of claim 23, further comprising:
receiving the ranging proxy indicator in a beacon frame transmitted by the candidate ranging proxy.

26. The apparatus of claim 25, wherein identifying the first ranging indicator comprises:
measuring a signal strength of the beacon frame to identify the first ranging indicator.

27. The apparatus of claim 26, further comprising:
mapping the signal strength to one of a plurality of signal strength levels.

28. The apparatus of claim 23, further comprising:
broadcasting a query for a ranging service; and
receiving the ranging proxy indicator from the candidate ranging proxy in response to the query.

29. The apparatus of claim 28, wherein identifying the first ranging indicator comprises:
measuring a signal strength of at least one transmission received from the candidate ranging proxy to identify the first ranging indicator.

30. A non-transitory computer-readable medium storing computer-executable code for wireless communication, the code executable by a processor to:
receive, at a first wireless device, a ranging proxy indicator from a candidate ranging proxy;
identify a first ranging indicator based at least in part on the ranging proxy indicator, the first ranging indicator indicating a proximity of the first wireless device to the candidate ranging proxy;
receive a second ranging indicator indicating a proximity of a second wireless device to the candidate ranging proxy; and
identify the first wireless device and the second wireless device being within a proximity threshold based at least in part on the first ranging indicator and the second ranging indicator.
